(19) United States
(12) Patent Application Publication
(10) Pub. No.: US 2025/0065957 A1
(43) Pub. Date: Feb. 27, 2025

(54) VEHICLE

(71) Applicant: TS TECH CO., LTD., Asaka-shi, Saitama (JP)

(72) Inventors: Jinichi TANABE, Tochigi (JP); Hiroyuki KAKU, Tochigi (JP); Hirohisa ABE, Tochigi (JP); Kensuke MIZOI, Tochigi (JP); Hiroshi BABA, Tochigi (JP); Yu ISHII, Tochigi (JP); Shoichi TAKAHASHI, Tochigi (JP); Munetaka KOWA, Tochigi (JP); Hayato SHIMAZAKI, Tochigi (JP)

(21) Appl. No.: 18/701,880

(22) PCT Filed: Oct. 19, 2022
(86) PCT No.: PCT/JP2022/038975

§ 371 Date: Oct. 16, 2024

Related U.S. Application Data
(60) Provisional application No. 63/257,688, filed on Oct. 20, 2021.
(60) Provisional application No. 63/272,303, filed on Oct. 27, 2021.
(60) Provisional application No. 63/274,240, filed on Nov. 1, 2021.
(60) Provisional application No. 63/298,264, filed on Jan. 11, 2022.
(60) Provisional application No. 63/322,693, filed on Mar. 23, 2022.

(51) Int. Cl. B62D 25/20

(52) U.S. Cl. CPC B62D 25/2027

(57) ABSTRACT

Provided is a vehicle that allows the feet of an occupant to be flat. A vehicle V includes: a seat S on which an occupant is seated; a rail 20 for sliding the seat; a first floor FS1 in which a plurality of protrusion portions 10 protruding upward are formed; and a second floor FS2 provided above the first floor FS1, in which the rail 20 is disposed below the second floor FL2 and across the plurality of protrusion portions 10 of the first floor FL1, and the seat S is disposed above the second floor FL2 and is slidably connected to the rail 20.

### TECHNICAL FIELD

The present invention relates to a vehicle, and particularly to a vehicle having a protrusion portion on a vehicle body floor.

### BACKGROUND ART

In the related art, as described in PATENT LITERATURE 1, a vehicle is known in which a plurality of protrusion portions (referred to as floor members in PATENT LITERATURE 1) that are arranged in a front to rear direction and extend in a right to left direction are provided on a vehicle body floor of an electric vehicle, and a slide rail is disposed to straddle the protrusion portions.

### CITATION LIST

### Patent Literature

PATENT LITERATURE 1: JP 2021-115933 A

### SUMMARY OF INVENTION

### Technical Problem

However, since the protrusion portions are provided on the floor, there are cases where the feet of an occupant who is seated on a conveyance seat may hit the protrusion portions, or cleaning under the conveyance seat becomes difficult.

Furthermore, in recent years, with the trend toward electrification of power sources, batteries are being installed under the floor, and there is a demand for vehicles or conveyance seats to have more functions than before.

The present invention has been made in view of the above-mentioned problems, and an object thereof is to provide a vehicle that allows the feet of an occupant to be flat. Another object thereof is to provide a vehicle in which a floor can have various functions.

### Solution to Problem

The foregoing problem is solved by a vehicle according to the present invention including: a seat on which an occupant is seated; a rail for sliding the seat; a first floor in which a plurality of protrusion portions protruding upward are formed; and a second floor provided above the first floor, in which the rail is disposed below the second floor and across the plurality of protrusion portions of the first floor, and the seat is disposed above the second floor and is slidably connected to the rail.

According to the present invention, it is possible to provide the vehicle in which the second floor is provided above the first floor, the rail is disposed below the second floor, and an upper surface of the second floor is allowed to be flat, thereby allowing the feet of an occupant to be flat.

In addition, by providing the first floor and the second floor thereabove, a space is created, so that it becomes possible to provide the floors with various functions.

In addition, in the vehicle described above, each of the plurality of protrusion portions may extend in a vehicle width direction, and the plurality of protrusion portions may be arranged in a vehicle front to rear direction.

Accordingly, rigidity of the vehicle can be improved.

In addition, in the vehicle described above, a plurality of the seats may be provided, and two or more of the seats may be disposed on the rail in a front to rear direction of the vehicle.

By allowing the plurality of seats to share the rail, for example, a movement range of the seats can be expanded and convenience can be improved.

In addition, in the vehicle described above, the rail may be disposed across three or more protrusion portions.

Accordingly, the rail can be supported by three or more protrusion portions, and a supporting force for supporting the rail can be improved.

In addition, the vehicle described above may further include a rail support member that is disposed between the plurality of protrusion portions and supports the rail from below.

By providing the rail support member between the protrusion portions, the supporting force for supporting the rail can be improved.

In addition, in the vehicle described above, at least one of the plurality of protrusion portions may be formed to be lower in height than the other protrusion portions, and a raising member may be provided on the protrusion portion that is lower in height than the other protrusion portions to match a height of the other protrusion portions.

By providing the raising member on the protrusion portion that is lower in height than the other protrusion portions, the heights are uniformized, and the rail can be easily installed.

In addition, in the vehicle described above, a recess portion may be formed on an upper surface of the plurality of protrusion portions, and the rail may be disposed in the recess portion.

By providing the recess portion in the protrusion portion and disposing the rail in the recess portion, a height of the rail can be lowered, and accordingly a height of the second floor can also be lowered.

In addition, in the vehicle described above, one end of the rail may be in contact with a side surface of a vehicle body structure portion that stands up from the first floor.

By bringing one end of the rail into contact with the side surface of the vehicle body structure portion, resistance to an impact in the front to rear direction can be improved.

In addition, in the vehicle described above, the rail may be constituted by a lower rail fixed to the first floor and an upper rail that slides on the lower rail, and the upper rail may be provided with a seat attachment/detachment mechanism for attachably/detachably connecting the seat.

By allowing the seat to be detachable, the seat can be replaced and seats of various sizes can be applied.

In addition, in the vehicle described above, a plurality of the rails may be provided, and a floor support member that is disposed between the plurality of rails on the first floor and supports the second floor may be provided.

By providing the floor support member between the rails, it is possible to prevent the second floor from bending.

### Advantageous Effects of Invention

According to the present invention, it is possible to provide the vehicle in which the second floor is provided above the first floor, the rail is disposed below the second floor, and an upper surface of the second floor is allowed to be flat, thereby allowing the feet of an occupant to be flat.

In addition, by providing the first floor and the second floor thereabove, the space is created, so that it becomes possible to provide the floors with various functions.

According to the present invention, since each of the plurality of protrusion portions extends in the vehicle width direction, and the plurality of protrusion portions are arranged in the vehicle front to rear direction, the rigidity of the vehicle can be improved.

According to the present invention, by allowing the plurality of seats to share the rail, for example, a movement range of the seats can be expanded and convenience can be improved.

According to the present invention, since the rail is disposed across three or more protrusion portions, the rail can be supported by three or more protrusion portions, and a supporting force for supporting the rail can be improved.

According to the present invention, by providing the rail support member between the protrusion portions, the supporting force for supporting the rail can be improved.

According to the present invention, by providing the raising member on the protrusion portion that is lower in height than the other protrusion portions, the heights are uniformized, and the rail can be easily installed.

According to the present invention, by providing the recess portion in the protrusion portion and disposing the rail in the recess portion, the height of the rail can be lowered, and accordingly the height of the second floor can also be lowered.

According to the present invention, by bringing one end of the rail into contact with the side surface of the vehicle body structure portion, the rigidity of the vehicle can be improved.

According to the present invention, by allowing the seat to be detachable, the seat can be replaced and seats of various sizes can be applied.

According to the present invention, by providing the floor support member between the rails, it is possible to prevent the second floor from bending.

### BRIEF DESCRIPTION OF DRAWINGS

FIG. 1 is a top view schematically showing configuration of a vehicle according to the present embodiment.

FIG. 2 is a perspective view schematically showing a configuration of a vehicle body floor.

FIG. 3 is a cross-sectional view schematically showing the configuration of the vehicle body floor.

FIG. 4 is a perspective view schematically showing a configuration of a vehicle body floor including a rail support member.

FIG. 5 is a cross-sectional view schematically showing the configuration of the vehicle body floor including the rail support member.

FIG. 6A is a cross-sectional view schematically showing a vehicle body floor in which a raising member is disposed on one of protrusion portions.

FIG. 6B is a cross-sectional view taken along line B-B in FIG. 6A, and is a schematic diagram showing an example of disposition of the raising member.

FIG. 7 is a top view schematically showing a vehicle body floor on which a long rail is supported by the rail support member.

FIG. 8A is a cross-sectional view schematically showing a protrusion portion in which a recess portion is formed.

FIG. 8B is a cross-sectional view schematically showing another example of the protrusion portion in which a recess portion is formed.

FIG. 8C is a cross-sectional view schematically showing a protrusion portion in which a recess portion is formed in a raising member.

FIG. 9A is a cross-sectional view schematically showing a configuration of a vehicle body floor in which a rail support member is disposed on a battery.

FIG. 9B is a cross-sectional view schematically showing a configuration of a vehicle body floor in which a rail support member is disposed on a battery in which a recess portion is formed.

FIG. 10A is a top view schematically showing a configuration of a vehicle body floor in which a second floor is provided in a region of long rails.

FIG. 10B is a cross-sectional view taken along line B-B in FIG. 10A, and is a schematic view showing the configuration of the vehicle body floor in which the second floor is provided in the region of the long rails.

FIG. 11A is a top view schematically showing a configuration of a vehicle body floor including a long rail that is in contact with a vehicle body structure portion.

FIG. 11B is a cross-sectional view taken along line B-B in FIG. 11B, and is a schematic view showing the configuration of the vehicle body floor including the long rail that is in contact with the vehicle body structure portion.

FIG. 12A is a cross-sectional view schematically showing a vehicle body floor including an inclined second floor.

FIG. 12B is a cross-sectional view schematically showing another example of the vehicle body floor including an inclined second floor.

FIG. 13 is a schematic view showing a vehicle body floor in which an airbag is provided in a long rail.

FIG. 14 is a schematic view showing another example of the vehicle body floor in which an airbag is provided in a long rail.

FIG. 15 is a schematic view showing a configuration of a vehicle body floor provided with a seat attachment/detachment mechanism.

FIG. 16A is a schematic view showing a position of a striker connected to a vehicle seat.

FIG. 16B is a schematic view showing another example of the position of the striker connected to the vehicle seat.

FIG. 17A is an explanatory view showing a method of releasing a rail lock mechanism disposed under a floor, and is a view showing a locked state.

FIG. 17B is an explanatory view showing the method of releasing the rail lock mechanism disposed under the floor, and is a view showing a state in which locking is released.

FIG. 18 is a top view of a vehicle body floor schematically showing a positional relationship between vehicle seats and long rails.

FIG. 19 is a side view of an armrest disposed next to the vehicle seat.

FIG. 20 is a schematic view showing a configuration of a vehicle body floor in which a storage portion is provided below a second floor.

FIG. 21A is a schematic view showing a configuration of a vehicle body floor showing a folded vehicle seat stored in a storage portion.

FIG. 21B is a schematic view showing the configuration of the vehicle body floor showing the vehicle seat in a seatable state.

FIG. 22A is a top view schematically showing a configuration of a vehicle body floor in which a floor support member is disposed.

FIG. 22B is a cross-sectional view schematically showing the configuration of the vehicle body floor in which the floor support member is disposed.

FIG. 23 is a perspective view showing a protrusion portion provided with a foot mounting portion.

FIG. 24 is a cross-sectional view schematically showing a vehicle seat fixed by a foot bracket.

FIG. 25A is a top view schematically showing a configuration of a vehicle in which a lid for battery replacement is disposed between long rails.

FIG. 25B is a sectional view taken along line B-B in FIG. 25A, and is a sectional view schematically showing the configuration of the vehicle in which the lid for battery replacement is disposed between the long rails.

FIG. 26A is an explanatory view showing a state in which vehicle seats have been moved forward.

FIG. 26B is an explanatory view showing a state in which the vehicle seats have been moved rearward.

FIG. 27A is a cross-sectional view schematically showing a vehicle body floor including a battery in which a rail is embedded.

FIG. 27B is a cross-sectional view schematically showing a vehicle body floor provided with a rail mounting bracket on a battery.

FIG. 28 is a top view schematically showing a vehicle body floor including a rail mounting bracket.

FIG. 29A is a schematic cross-sectional view of a vehicle body floor showing another example of the rail mounting bracket.

FIG. 29B is a schematic cross-sectional view of a vehicle body floor showing another example of the rail mounting bracket.

FIG. 30 is a schematic cross-sectional view showing a rear seat supported by a base made of expanded polypropylene (EPP).

FIG. 31 is a schematic cross-sectional view showing a rear seat supported by a base made of expanded polypropylene (EPP) provided with a reinforcing member.

FIG. 32 is a schematic cross-sectional view of a vehicle body floor in which a storage portion is provided below a seat.

FIG. 33 is a schematic top view of an interior of a vehicle cabin in which a removable table is provided.

FIG. 34 is a schematic cross-sectional view of a vehicle body floor in which a shock absorbing material is provided between a battery and a floor.

FIG. 35 is a schematic cross-sectional view of a vehicle body floor in which a reinforcing panel or a floor mat is provided on an upper part of the floor.

FIG. 36A is a schematic cross-sectional view showing a configuration of a storage portion that stores a rear dive-down seat in the related art.

FIG. 36B is a schematic cross-sectional view of a vehicle body floor including a storage portion with an inclined bottom surface.

FIG. 37A is a schematic perspective view showing a mounting structure for a flip-up type vehicle seat in the related art.

FIG. 37B is a schematic perspective view showing a mounting structure for a flip-up type vehicle seat in which a mounting portion is provided on a protrusion portion of a floor.

FIG. 38 is an explanatory view describing a volume occupied by a seat when a vehicle seat having a vertical direction as a rotation axis is rotated.

FIG. 39A is a top view showing a rear seat that is movable in a front to rear direction.

FIG. 39B is an explanatory view describing a rear seat having an air cell in a side portion.

FIG. 40A is a schematic view showing a configuration of the seat cushion of the rear seat in a normal state.

FIG. 40B is a schematic view showing the seat cushion in a state where the seat width is narrowed.

FIG. 41 is an explanatory view describing a vehicle seat in which an air cell is provided in a front portion of a seat cushion and a length in the front to rear direction is changed.

FIG. 42 is a schematic view showing a configuration of a vehicle provided with a dive-down type rear seat provided above a battery.

FIG. 43 is a state transition diagram showing a transition of the dive-down type rear seat in the event of a rear collision.

FIG. 44 is a schematic view showing a configuration of a charging plug.

FIG. 45A is a schematic configuration view seen from above, showing a configuration of a vehicle with a replaceable battery.

FIG. 45B is a schematic cross-sectional view seen from a side, showing the configuration of the vehicle with the replaceable battery.

FIG. 45C is a schematic cross-sectional view seen from a front, showing the configuration of the vehicle with the replaceable battery.

FIG. 46A is a schematic configuration view seen from above, showing another configuration of the vehicle with a replaceable battery.

FIG. 46B is a schematic cross-sectional view seen from a side, showing another configuration of the vehicle with a replaceable battery.

FIG. 46C is a schematic cross-sectional view seen from a front, showing another configuration of the vehicle with a replaceable battery.

FIG. 47 is a schematic configuration view seen from a side, showing a first example of an occupant protection device.

FIG. 48 is a schematic configuration view seen from a front, showing the first example of the occupant protection device.

FIG. 49 is a perspective view showing the first example of the occupant protection device when stored.

FIG. 50A is a schematic configuration view seen from a side, showing a second example of the occupant protection device.

FIG. 50B is a perspective view showing the second example of the occupant protection device when stored.

FIG. 51A is a schematic configuration view seen from a side, showing a third example of the occupant protection device.

FIG. 51B is a perspective view showing the third example of the occupant protection device when stored.

FIG. 52A is a schematic configuration view seen from a front, showing the third example of the occupant protection device.

FIG. 52B is a schematic configuration view of the third example of the occupant protection device view seen from a front when stored.

FIG. 53A is a schematic configuration view seen from a side, showing a fourth example of the occupant protection device.

FIG. 53B is a schematic configuration view seen from a front, showing the fourth example of the occupant protection device.

FIG. 54 is a schematic configuration view seen from a side, showing a fifth example of the occupant protection device.

### DESCRIPTION OF EMBODIMENTS

### First Embodiment

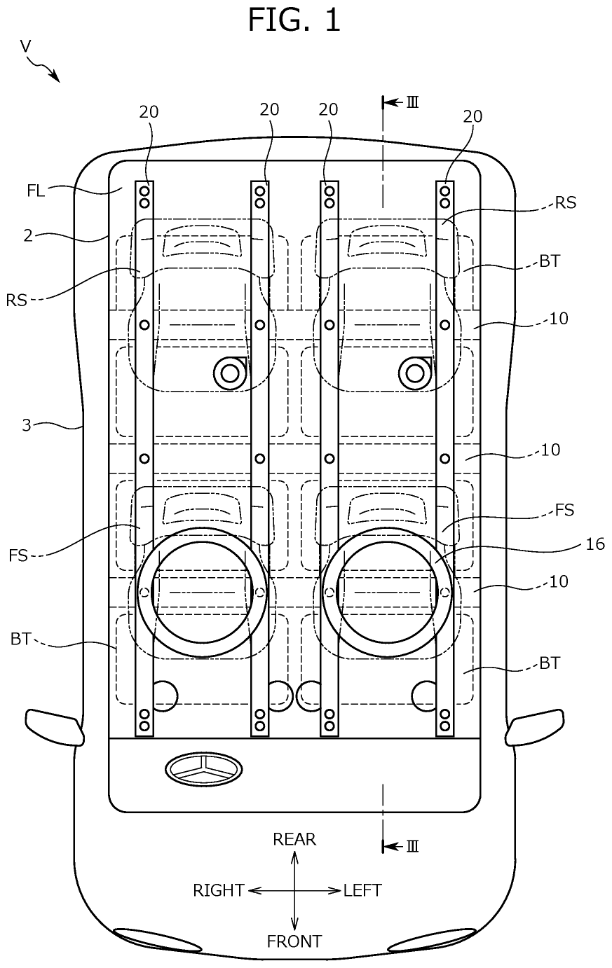

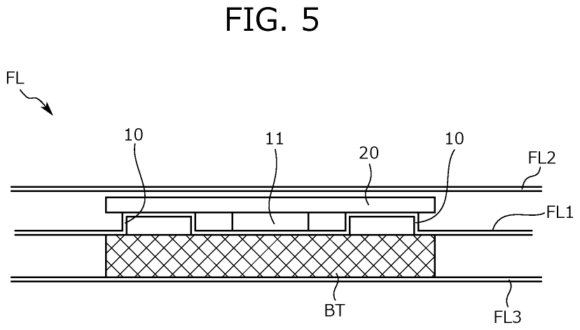

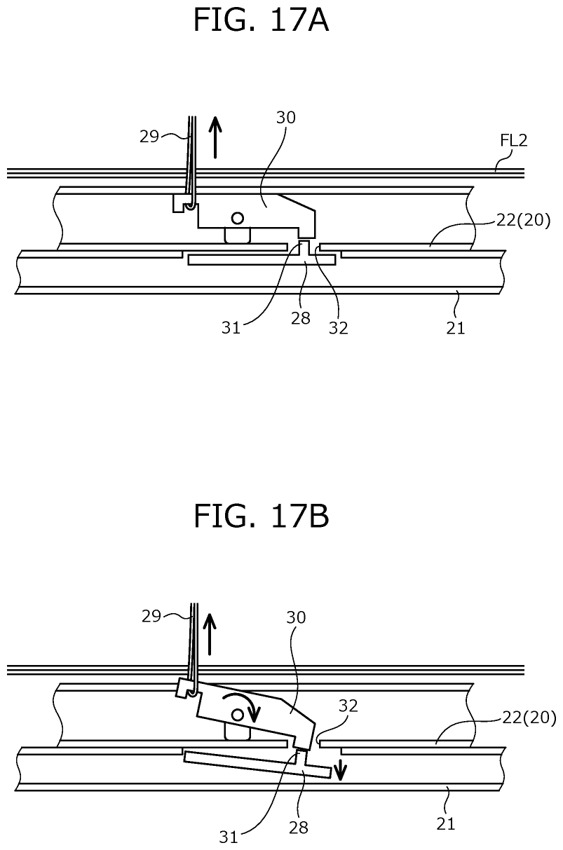

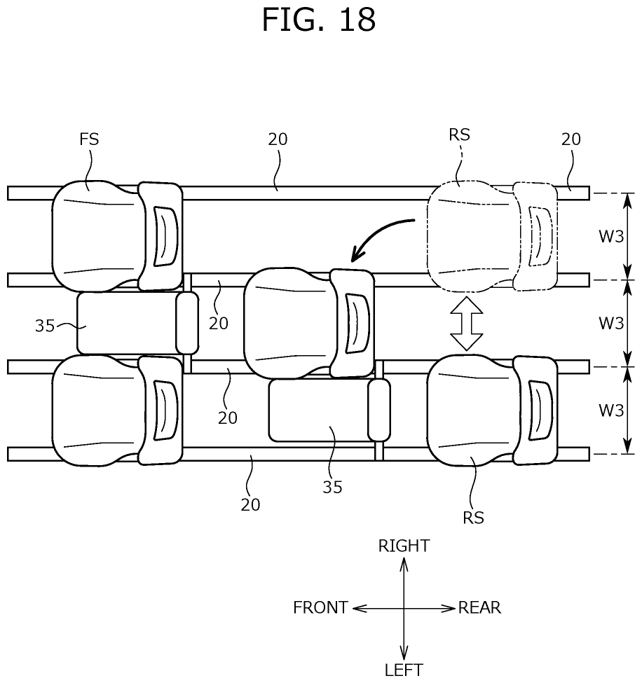

Hereinafter, a vehicle V according to a first embodiment of the present invention (hereinafter, referred to as the present embodiment) will be described with reference to FIGS. 1 to 22B. Embodiments described below are merely examples for facilitating understanding of the present invention, and do not limit the present invention. That is, shapes, dimensions, arrangement, and the like of members described below may be changed and improved without departing from the gist of the present invention, and as a matter of course, the present invention includes equivalents thereof.

Hereinafter, as an example of a vehicle, the vehicle V, which is a four-wheeled electric vehicle (EV vehicle) having four wheels, shown in FIG. 1, is adopted, and a configuration example thereof will be described.

However, the applicable vehicle V is not limited to the four-wheeled electric vehicle, but may also be applied to engine vehicles, hybrid vehicles including both a motor and an engine for traveling, and vehicles in which a battery and a fuel cell are installed as a power source.

Furthermore, in the following description, a “front to rear direction” refers to a front to rear direction of the vehicle and a vehicle seat, and is a direction that coincides with a traveling direction when the vehicle travels. In addition, a “right to left direction” or “vehicle width direction” refers to a transverse direction of the vehicle, and is a direction that coincides with a right to left direction as seen from an occupant seated on the vehicle seat. In addition, an “up to down direction” refers to an up to down direction of the vehicle, and is a direction that coincides with a vertical direction when the vehicle travels on a horizontal plane. In addition, a case where “outside” is simply mentioned indicates a side closer to an outside in a direction from a center toward the outside of the vehicle, and a case where “inside” is mentioned means a side closer to the center in a direction from the outside toward the center of the vehicle.

Also, a case where “seat outside” is mentioned points to a side closer to a side closer to an outside in a direction from a center toward the outside of the vehicle seat, and a case where “seat inside” is mentioned means a side closer to the center in a direction from the outside toward the center of the vehicle seat.

A shape, position, and posture of each part of the vehicle seat provided in the vehicle described below will be described assuming that the vehicle seat is in a seated state, unless otherwise specified.

### Basic Configuration of Vehicle V

As shown in FIG. 1, the vehicle V to which the present invention is applied has a vehicle structure including a vehicle body 3 defining a vehicle cabin 2, and four wheels (not shown) including right and left pairs of front and rear wheels.

The vehicle body 3 has a pair of right and left side members (not shown) extending in the front to rear direction of the vehicle V, and a vehicle body floor FL. On the vehicle body floor FL, a front seat FS serving as a driver seat or an occupant seat and a rear seat RS located on a rear side are disposed in order from front to rear of the vehicle V. A middle seat may be provided between the front seat FS and the rear seat RS.

The front seat FS and the rear seat RS are provided with a slide mechanism, and can be moved in the front to rear direction by long rails 20 provided on the vehicle body floor FL.

The vehicle seat S may be provided with a rotating device 16. By rotating the vehicle seat S with the vertical direction as an axis using the rotating device 16, a direction in which the occupant is seated can be changed.

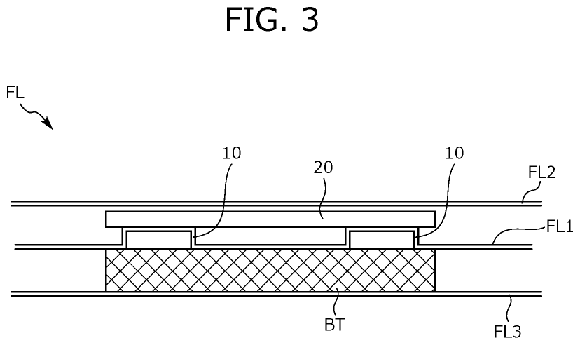

In addition, in the vehicle body floor FL, a battery BT for supplying electric power to an electric motor of the vehicle V, and a vehicle body bottom portion FL3 (see FIG. 3) that supports the battery BT from below are provided.

In a vehicle in the related art, a protrusion portion extending in the right to left direction (vehicle width direction) is provided on a floor, and a leg portion or a slide mechanism of the vehicle seat is attached to the protrusion portion. Therefore, there are cases where a foot of the occupant hits the protrusion portion or cleaning under the vehicle seat becomes difficult.

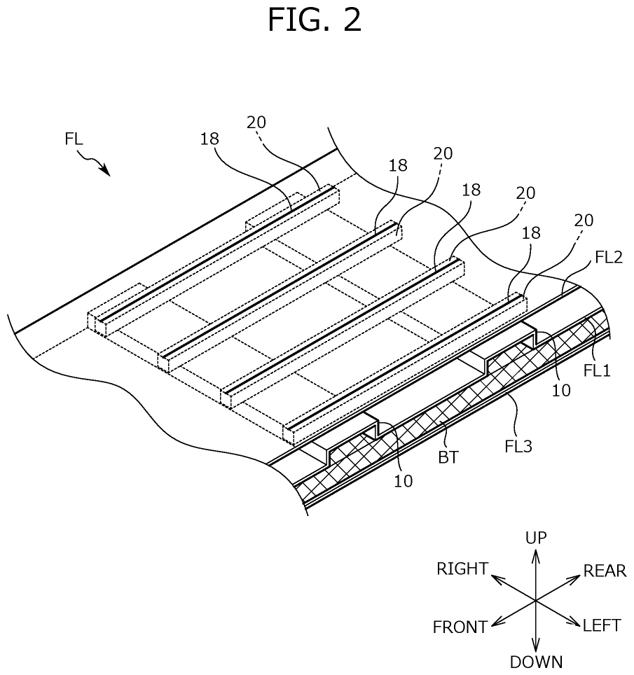

In the vehicle V of the present embodiment, as shown in FIG. 2, the vehicle body floor FL is configured to include a first floor FL1 on which a plurality of protrusion portions 10 that protrude upward are formed, and a second floor FL2 provided above the first floor FL1.

Each of the plurality of protrusion portions 10 extends in the vehicle width direction. In addition, the plurality of protrusion portions 10 are disposed parallel to each other at intervals in the front to rear direction of the vehicle V.

The vehicle body bottom portion FL3, the first floor FL1, and the second floor FL2, which constitute the vehicle body floor FL, are formed of steel unless otherwise specified. In addition, the protrusion portion 10 of the first floor FL1 is formed, for example, by press-forming a steel plate.

The vehicle V is provided with the long rails 20 for sliding the front seat FS and the rear seat RS in the front to rear direction. The long rail 20 is disposed below the second floor FL2 and across the plurality of protrusion portions 10 of the first floor FL1, and the front seat FS and the rear seat RS are disposed above the second floor FL2 and slidably connected to the long rails 20 through slits 18 formed in the second floor FL2.

More specifically, the long rail 20 is constituted by a lower rail 21 fixed to the vehicle body, and an upper rail 22 that is connected to the vehicle seat S and slides on the lower rail 21.

The lower rail 21 of the long rail 20 is long in the front to rear direction, and the upper rail 22 connected to each of the front seat FS and the rear seat RS can be individually slid. Since the front seat FS and the rear seat RS share the lower rail 21, a movement range can be expanded and convenience can be improved.

By providing the second floor FL2 above the first floor FL1 and disposing the long rail 20 below the second floor FL2, an upper surface of the second floor FL2 is allowed to be flat. Accordingly, the feet of the occupant seated on the front seat FS and the rear seat RS is allowed to be flat.

In addition, by placing the long rail 20 on the protrusion portions 10 of the first floor FL1, rigidity of the vehicle body floor FL can be improved.

In addition, in examples shown in FIGS. 2 and 3, the long rail 20 is disposed across two protrusion portions 10, but this is merely an example. In a case where three or more protrusion portions 10 are provided, the long rail 20 may be disposed across three or more protrusion portions 10.

### Rail Support Member 11

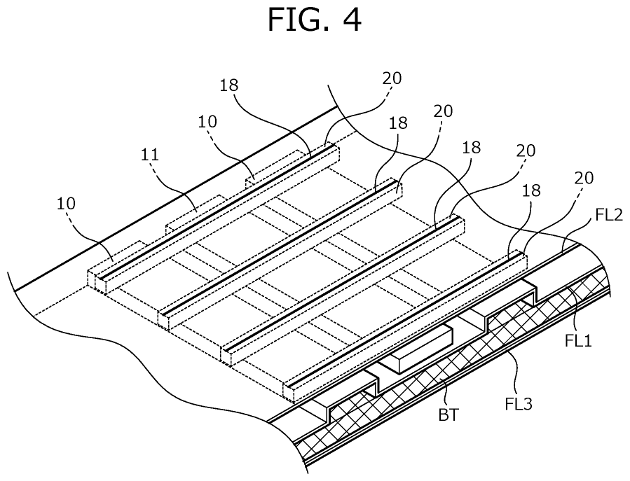

In addition, as shown in FIG. 4, a rail support member 11 that supports the long rail 20 (more specifically, the lower rail 21) from below may be provided between the plurality of protrusion portions 10 formed on the first floor FL1.

In addition, the rail support member 11 shown in FIG. 4 extends in the vehicle width direction similarly to the protrusion portion 10, and a plurality of long rails 20 are supported by the rail support member 11.

Alternatively, a plurality of rail support members 11 disposed in a row in the vehicle width direction may be disposed below each of the long rails 20 to individually support the long rail 20.

### Raising Member 12

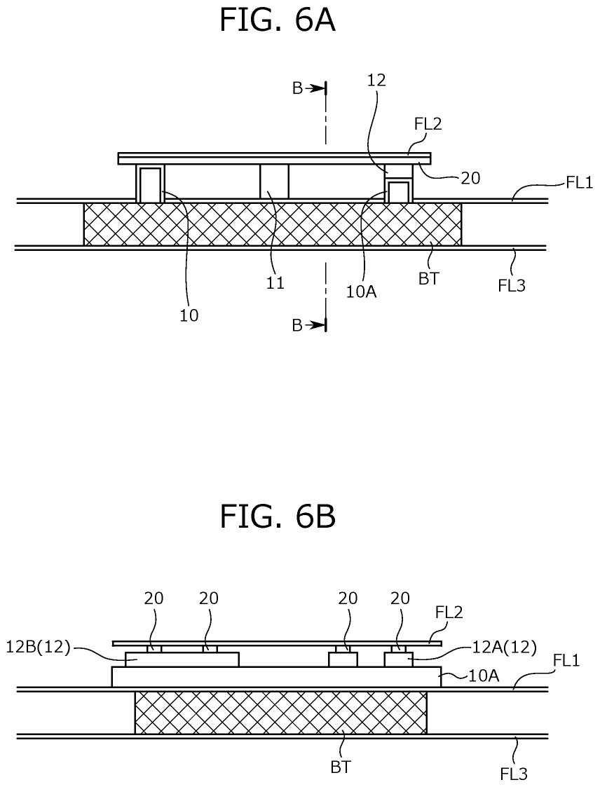

In addition, in a case where the long rail 20 is supported by the plurality of protrusion portions 10 or rail support members 11, heights of the protrusion portions 10 and rail support members 11 supporting the long rail 20 need to be uniform. However, as shown in FIG. 6A, there are cases where a protrusion portion 10A that does not match the height of other protrusion portions 10 or rail support members 11 is present. In such a case, as shown in FIG. 6A, a raising member 12 that matches the height of the other protrusion portions 10 may be provided on the protrusion portion 10A, which is lower in height than the other protrusion portions 10. By providing the raising member 12 on the protrusion portion 10A which is lower in height than the other protrusion portions 10, the heights are uniformized, and the long rail 20 can be supported without being bent, so that the long rail 20 can be easily installed.

In addition, the raising member 12 may be provided to individually support the long rail 20 similarly to a raising member 12A shown in FIG. 6B. Moreover, similarly to a raising member 12B, the raising member 12 may be provided to support the plurality of long rails 20.

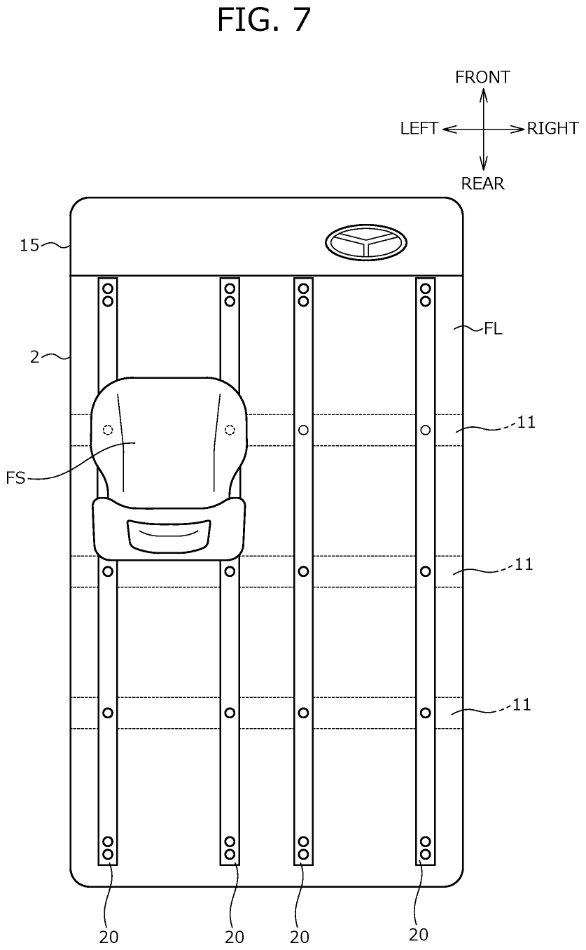

In addition, in a case where the protrusion portions 10 are not formed on the first floor FL1, as shown in FIG. 7, the plurality of rail support members 11 may be disposed on the first floor FL1, and the long rail 20 may be disposed across the plurality of rail support members 11.

### Formation of Recess Portion 13

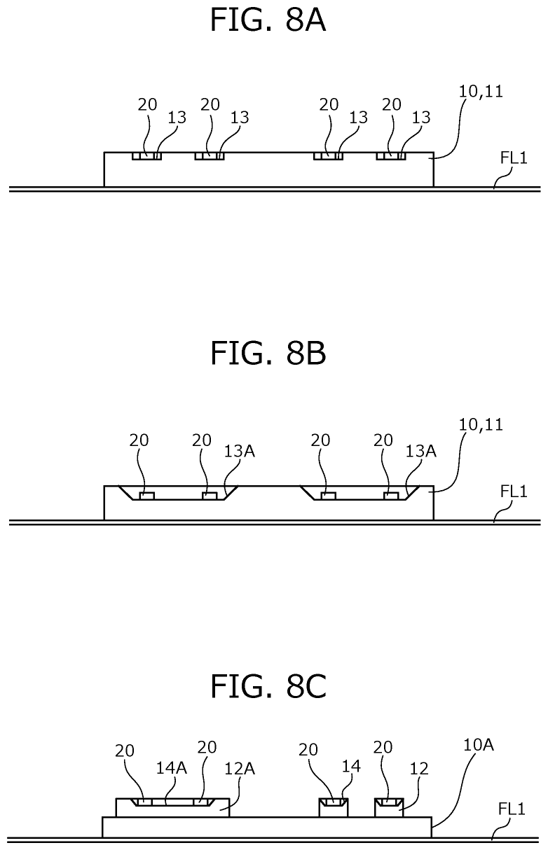

In addition, as shown in FIGS. 8A and 8B, recess portions 13 may be formed on an upper surface of the protrusion portion 10 or the rail support member 11 that supports the long rail 20. By forming the recess portion 13 and disposing the long rail 20 in the recess portion 13, a height of the long rail 20 (position in the up to down direction in the vehicle V) is lowered, thereby lowering a height of the second floor FL2. In addition, in a case where the height is higher than other protrusion portions 10 or rail support members 11, the height can be adjusted by forming the recess portion 13, and the long rail 20 can be supported without being bent.

In addition, the recess portions 13 may be formed to individually accommodate the long rails 20 as shown in FIG. 8A. In addition, similarly to recess portions 13A shown in FIG. 8B, the recess portions 13 may be formed to collectively accommodate the plurality of long rails 20.

In addition, as shown in FIG. 8C, in a case where the raising member 12 is provided on the protrusion portion 10, recess portions 14 may be formed in the raising member 12, and the long rail 20 may be accommodated in the recess portions 14. The recess portions 14 may individually accommodate the long rails 20 similarly to the recess portions 13 formed in the protrusion portion 10, or may accommodate the plurality of long rails 20 similarly to recess portions 14A.

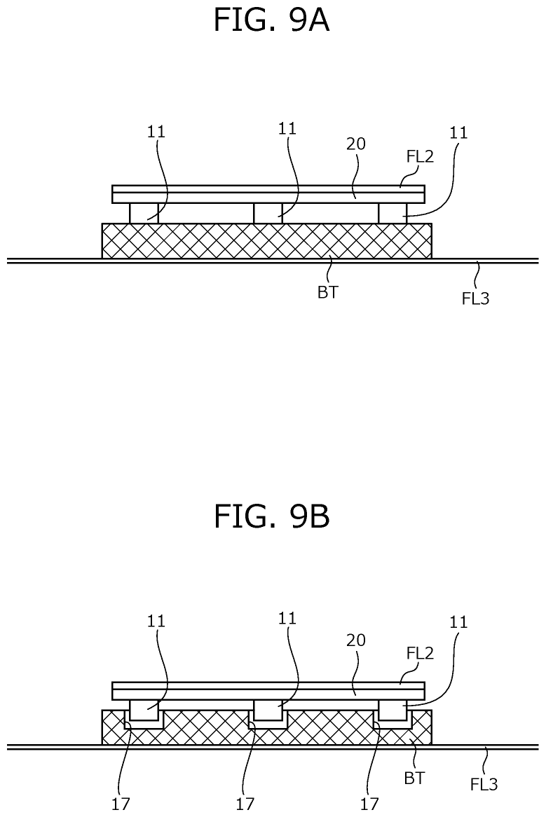

In addition, as shown in FIG. 9A, the rail support members 11 that supports the long rail 20 may be directly supported by the battery BT without providing the first floor FL1.

Alternatively, as shown in FIG. 9B, recess portions 17 may be formed in the battery BT, and the rail support members 11 may be stored in the recess portions 17 formed in the battery BT.

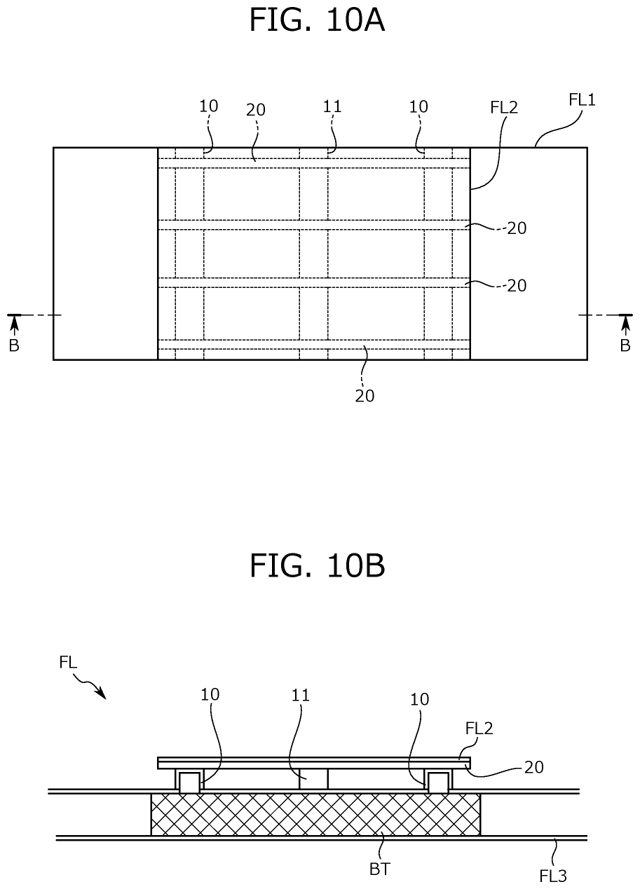

As shown in FIGS. 10A and 10B, the second floor FL2 may be formed only in a region where the long rail 20 is provided. That is, a length of the long rail 20 in the front to rear direction and a length of the second floor FL2 in the front to rear direction may equal to each other.

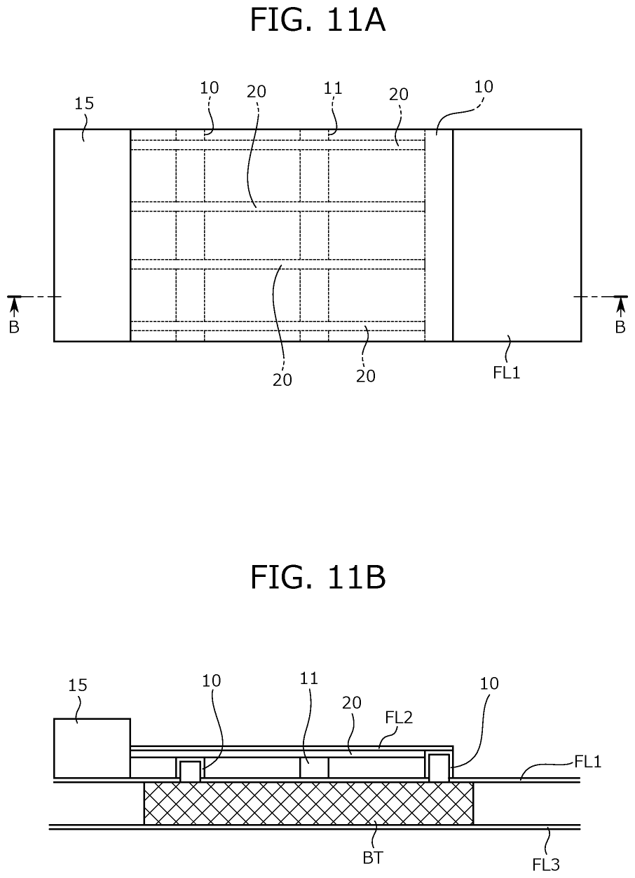

In addition, as shown in FIGS. 11A and 11B, the long rail 20 may be disposed so that a tip of the long rail 20 is brought into contact with a side surface of a front wall portion constituting a vehicle body structure portion 15 that stands up from the first floor FL1, for example, an instrument panel or a dashboard. By disposing the long rails 20 in this manner, resistance to an impact in the front to rear direction can be improved. In this case, a rear end of the long rail 20 may be fixed to be stuck in a side surface of the protrusion portion 10 or the rail support member 11.

In addition, by bringing the long rail 20 into contact with the vehicle body structure portion 15, a movement range of the front seat FS is increased. For example, by rotating the front seat FS with the rotating device 16, the front seat FS can be moved to a front of the vehicle cabin 2 for use.

### Inclination of Floor Surface

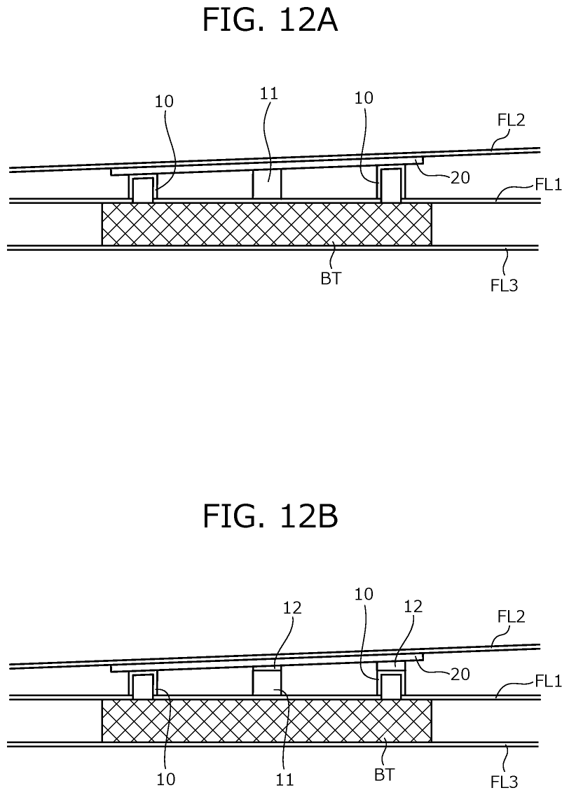

In addition, depending on a type of vehicle, there are cases where a floor surface that is inclined slightly downward toward the front is required instead of a floor surface that is parallel to the ground. In such a case, as shown in FIG. 12A, an inclined surface may be provided by changing the height of the protrusion portion 10 of the first floor FL1 or the rail support member 11 and inclining the long rail 20 and the second floor FL2.

In addition, as shown in FIG. 12B, an inclined surface may be provided by disposing the raising member 12 on the upper surface of the protrusion portion 10 or the rail support member 11 and inclining the long rail 20 and the second floor FL2.

### In-Rail Airbag Device

In a case where the long rail 20 is provided to widen the movement range of the vehicle seat S, there are cases where a sufficient reach is not implemented by an airbag provided in a dashboard or a steering wheel.

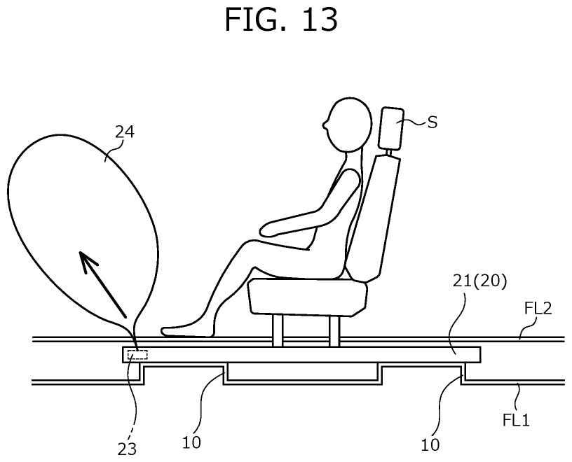

Therefore, as shown in FIG. 13, instead of an airbag built in the dashboard or the steering wheel, an airbag device 23 may be provided at a tip of the long rail 20 (more specifically, the lower rail 21) so that an airbag 24 is deployed in a case of an impact.

Since a direction in which the airbag 24 is deployed (an arrow direction in FIG. 13) is not toward the occupant, the occupant can be protected more safely than the airbag built in the dashboard or the steering wheel.

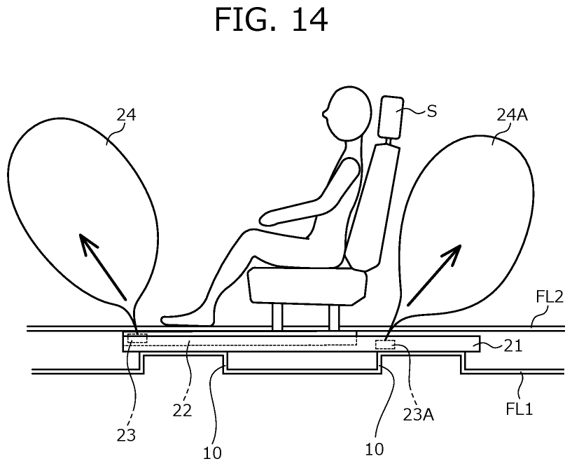

In addition, as shown in FIG. 14, the airbag device 23 may be attached to a tip of the upper rail 22 that slides along the lower rail 21 of the long rail 20. A position of the airbag device 23 is determined according to a position of the vehicle seat S, and the position at which the airbag 24 is deployed is stabilized.

In addition, as shown in FIG. 14, an airbag device 23A may be provided between the front seat FS and the rear seat RS. The occupant seated on the rear seat RS can also be protected by an airbag 24A.

In the long rail 20 of the vehicle V, a single long lower rail 21 is provided with upper rails 22 corresponding to the number of shared seats. Since the lower rail 21 is disposed below the second floor FL2, easy detachment between the vehicle seat S and the upper rail 22 is achieved, which provides convenience.

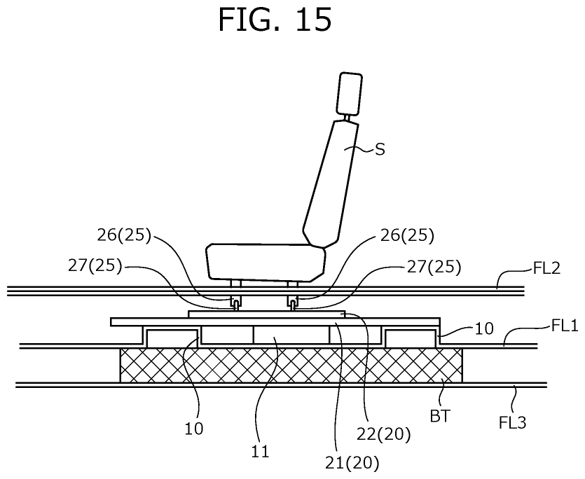

As shown in FIG. 15, the vehicle seat S of the present embodiment is provided with a seat attachment/detachment mechanism 25 at a bottom portion of the vehicle seat S, which attachably/detachably connects the vehicle seat S to the long rail 20. The seat attachment/detachment mechanism 25 is constituted by a lock member 26 serving as a leg portion under a seat cushion of the vehicle seat S, and a striker 27 provided on the upper rail. By engaging the lock member 26 with the striker 27, the vehicle seat S is attached to the long rail 20. In addition, by unlocking the lock member 26, the vehicle seat S can be easily detached from the long rail 20. Since the striker 27 is located below the second floor FL2, smoothness of the second floor FL2 is secured.

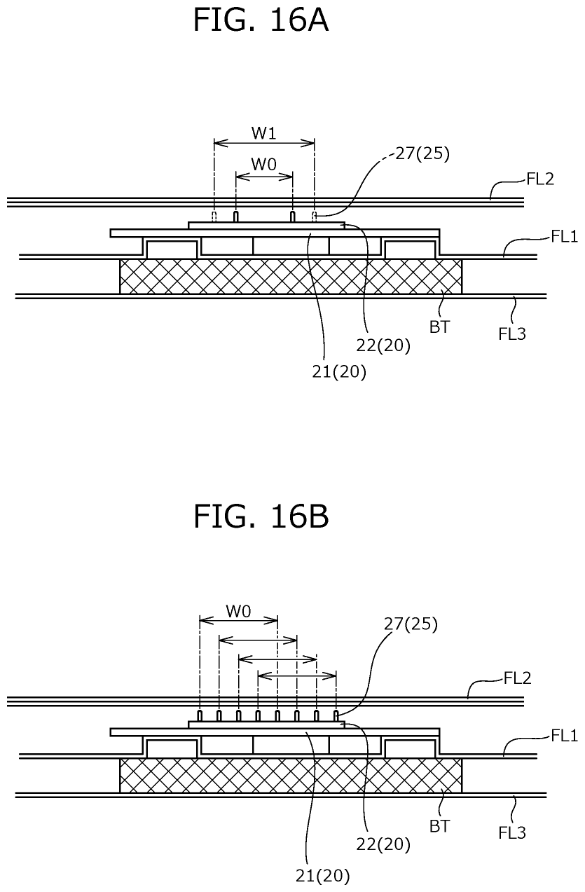

In addition, as shown in FIG. 16A, by widening an interval W0 between front and rear strikers 27 provided on the upper rail 22 to an interval W1, attachment of vehicle seats S of different sizes can be coped with. Four strikers 27 with different intervals may be provided on the upper rail 22 in advance.

In addition, as shown in FIG. 16B, in a case where a plurality of strikers 27 are disposed at equal intervals, attachment positions on the upper rail 22 can be changed, and positions can be adjusted by more than a sliding amount.

In the vehicle V of the present embodiment, since the long rail 20 is disposed below the second floor, it is difficult for the occupant to directly operate a lock device that restricts movement of the upper rail 22.

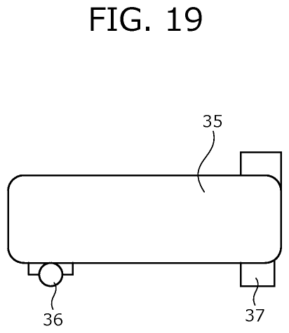

In the present embodiment, as shown in FIGS. 19A and 19B, the long rail 20 is configured such that a protruding portion 31 provided at an end portion of a lock spring 28 fits into a lock hole 32 provided in the upper rail 22 to restrict the movement of the upper rail 22. By pressing down this protruding portion 31, locking is released and the upper rail 22 can be slid.

In the present embodiment, a lever 30 for pressing down the protruding portion 31 of the lock spring 28 is configured to be provided on the upper rail 22 so that locking is released by operating the lever 30 with a cable 29. More specifically, when the occupant pulls the cable connected to an end portion of the lever in an upward direction, the lever rotates and presses down the protruding portion of the lock spring. By this operation of the lever, locking can be released from above the second floor FL2, thereby allowing the vehicle seat S to be moved.

Moreover, in the vehicle V of the present embodiment, four long rails 20 are disposed in the vehicle cabin, and the vehicle seat S is movable in the front to rear direction.

By arranging these four long rails 20 at equal intervals W3 in the right to left direction as shown in FIG. 18, the vehicle seat S can be attached using the two long rails 20 disposed in the middle, or an armrest 35 can be disposed between adjacent vehicle seats S. It is also possible to dispose armrests on right and left sides of the vehicle seat S arranged in the middle.

FIG. 19 is a side view of the armrest 35. As shown in FIG. 19, wheels 36 may be provided on a front side of the armrest 35, and lock devices 37 for fixing a position may be provided on a rear side.

As shown in FIG. 15, when the vehicle seat S is easily detached, the position of the vehicle seat S can be freely arranged. Furthermore, in addition to the armrest 35, options such as an ottoman and a table can be installed according to preference.

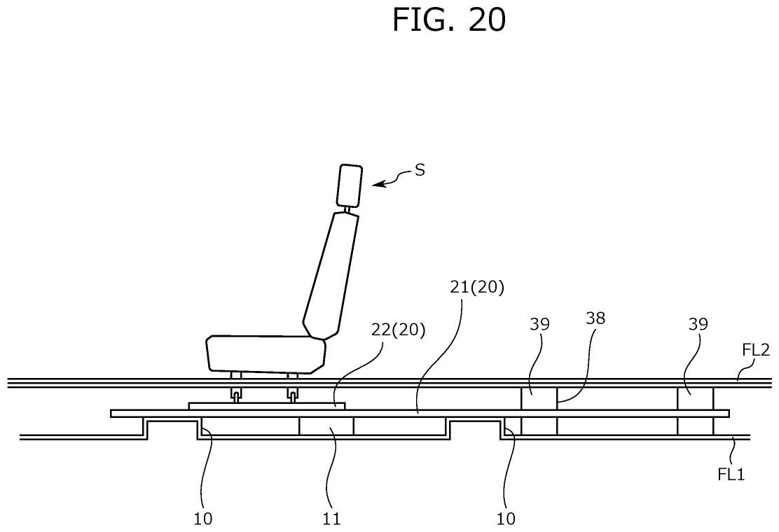

In addition, since the vehicle body floor FL of the present embodiment is provided with the first floor FL1 and the second floor FL2 thereon, a space is created between the first floor FL1 and the second floor FL2. Therefore, as shown in FIG. 20, a recess portion may be formed in the second floor FL2, and a storage portion 38 may be provided using the recess portion. The storage portion 38 can be used, for example, as a refrigerator or a shoe storage.

In addition, a floor reinforcing member 39 may be provided around the storage portion 38 to reinforce the second floor FL2. In addition to strengthening the vehicle body floor FL, it is also possible to improve strength of the storage portion itself.

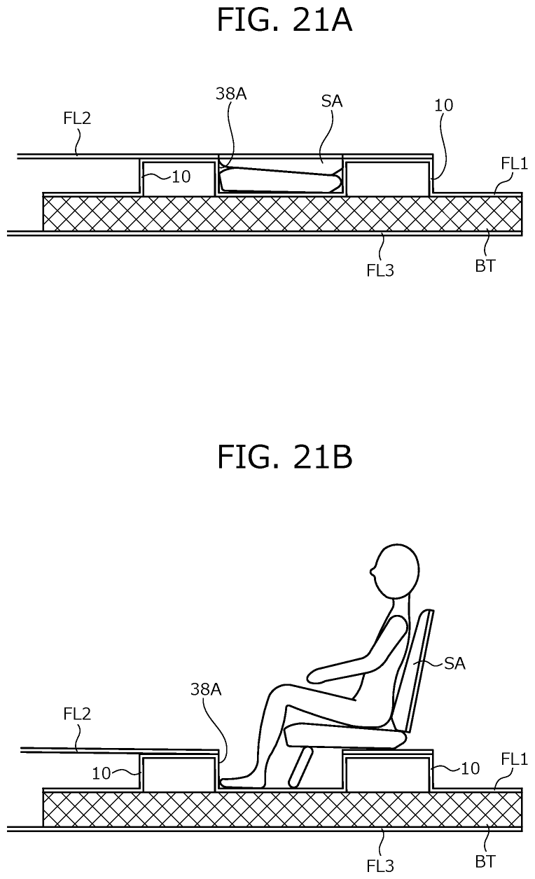

In addition, the storage portion 38 provided in the second floor FL2 may be used to store a vehicle seat SA that can dive down, similarly to a storage portion 38A shown in FIGS. 21A and 21B.

In addition, in a case where the storage portion 38 is used as a shoe storage, a sterilization device, such as an ultraviolet irradiation device, may be provided in the storage portion 38.

By providing the storage portion 38 below the second floor FL2, it is possible to effectively utilize a vacant space while presenting the upper surface of the second floor FL2 as flat.

In addition, since the storage portion 38 is disposed on the battery BT, it is possible to suppress transmission from the battery BT into the vehicle cabin.

### Floor Support Member 40

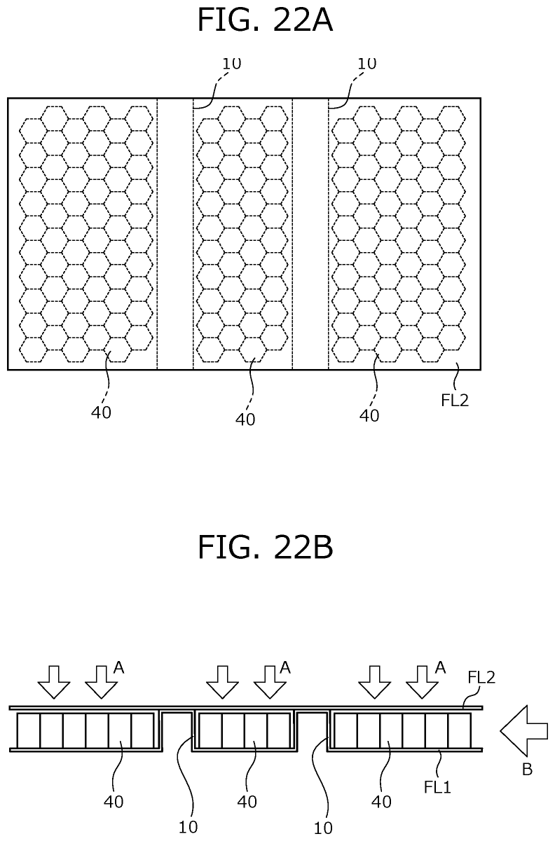

In addition, in a case where there is a space between the first floor FL1 and the second floor FL2, there is a possibility that a portion of the second floor FL2 that is not supported by the protrusion portion 10 of the first floor FL1 deflects in the vertical direction. In order to prevent this second floor FL2 from deflecting, a floor support member 40 that supports the second floor FL2 is provided between the first floor FL1 and the second floor FL2, as shown in FIGS. 22A and 22B. As the floor support member 40, a honeycomb plate having a honeycomb structure as shown in FIG. 22A may be used. In addition, it is desirable that the honeycomb plate is made of aluminum or carbon.

By providing the floor support member 40 made of the honeycomb plate, a reduction in weight can be achieved while maintaining strength in the vertical direction. Therefore, even in a case where a load is applied in the up to down direction (arrow A in FIG. 22B), deflection of the second floor FL2 can be prevented, and a reduction in smoothness can be suppressed. In addition, even in a case where an impact is applied from a side as indicated by arrow B in FIG. 22B, the honeycomb structure of the floor support member 40 can buffer the impact.

### Second Embodiment

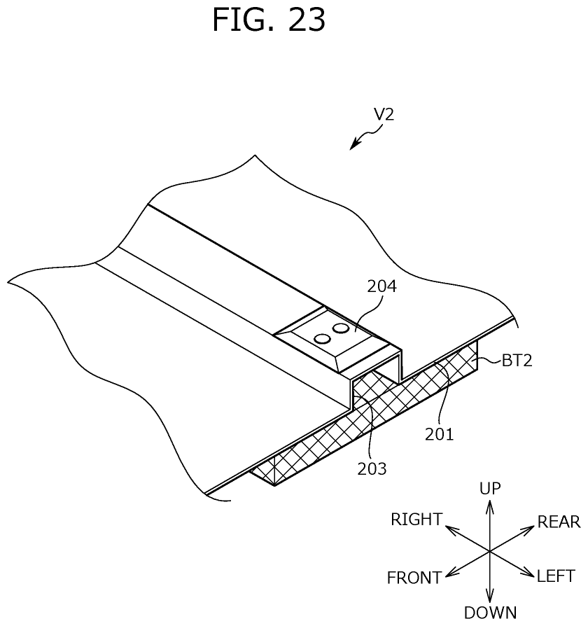

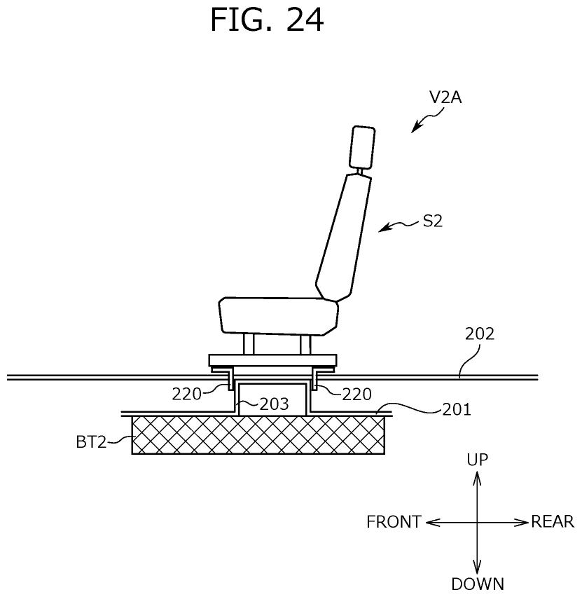

A second embodiment of the present invention will be described using FIGS. 23 and 24. The second embodiment relates to a vehicle in which a battery is disposed under a floor.

In the related art, a protrusion portion (floor member) extending in a right to left direction is formed in a frame of a vehicle floor to reinforce a vehicle body frame, and a vehicle seat is fixed to the protrusion portion using a foot bracket, which is a separate member from the protrusion portion.

In a vehicle V2 of the present embodiment, a first floor 201 is disposed on a battery BT2, and a protrusion portion 203 that reinforces the first floor 201 is formed. As shown in FIG. 23, a function of a foot bracket for mounting the vehicle seat S2 is formed as a foot mounting portion 204 on the protrusion portion 203 of the first floor 201 such that the foot bracket and the protrusion portion are integrated. The integration improves reinforcement performance, and the omission of the foot bracket achieves a reduction in weight of the vehicle seat S2.

In addition, in the related art, the seat is fixed by disposing the foot bracket on an upper surface of the protrusion portion. However, as in a vehicle body floor of a vehicle V2A shown in FIG. 24, foot brackets 220 may be mounted with the protrusion portion 203 of the first floor 201 interposed therebetween.

By mounting the foot brackets 220 with the protrusion portion 203 interposed therebetween in the front and rear directions and fixing the vehicle seat S2, for example, torsional rigidity can be improved, and mounting rigidity of the entire vehicle seat S2 can be further improved.

### Third Embodiment

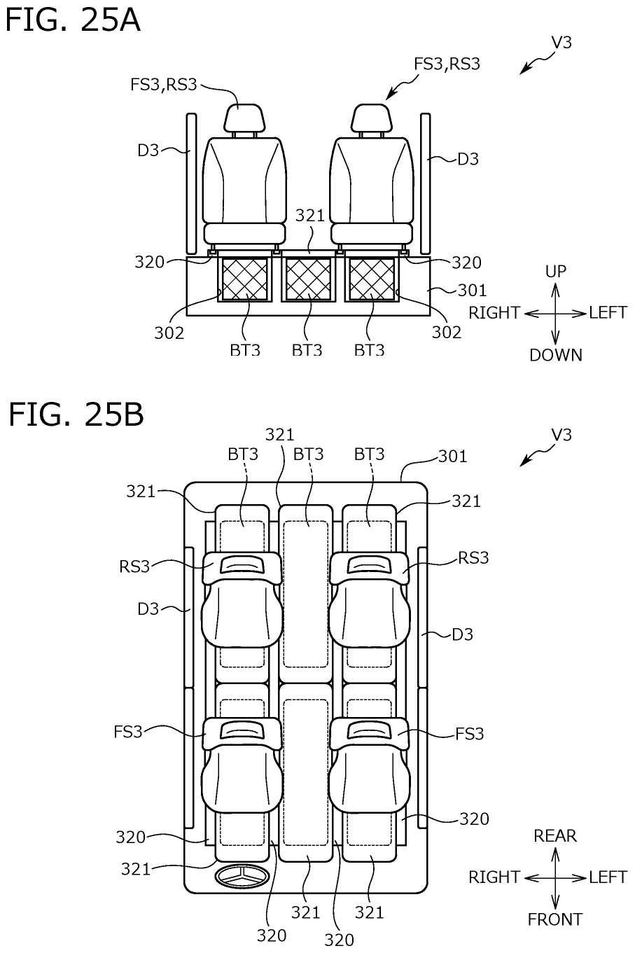

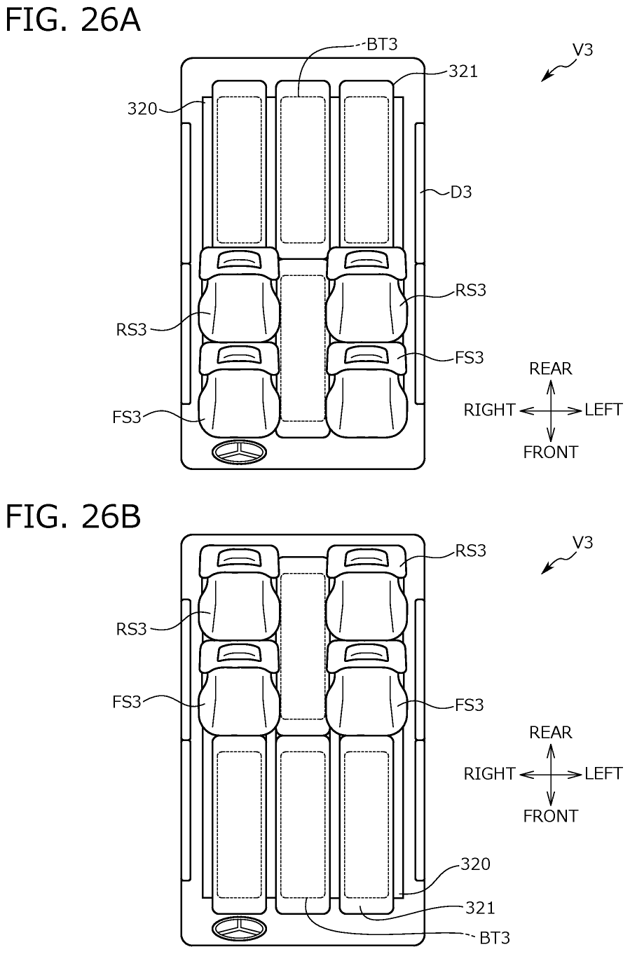

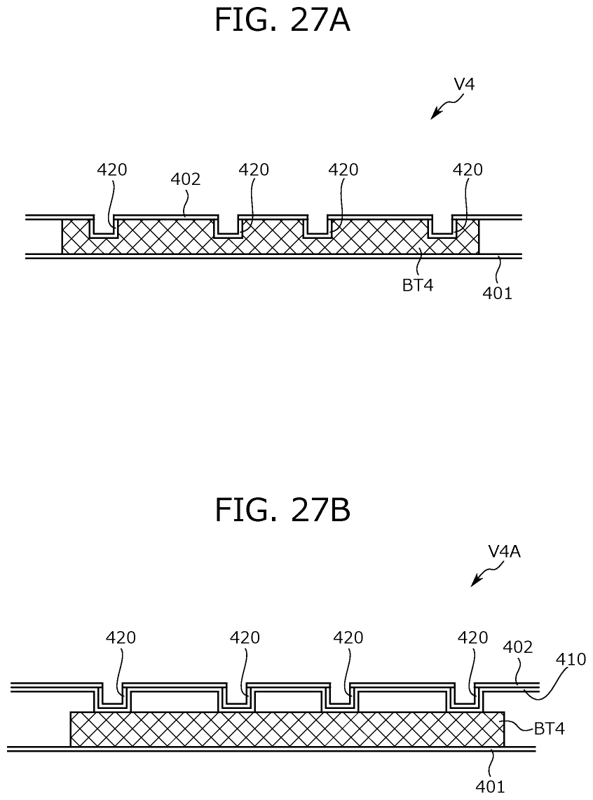

Next, a third embodiment of the present invention will be described using FIGS. 25A to 26B. The third embodiment relates to a vehicle in which a battery is disposed under a floor.

FIG. 25A is a sectional view schematically showing a vehicle V3 in which a lid 321 for battery replacement is arranged between long rails 320 provided on a floor 301, and FIG. 25B is a top view thereof.

As shown in FIGS. 25A and 25B, doors D3 are disposed on sides of the vehicle V3, and the floor 301 is provided below the doors D3. Recess portions 302 extending in the front to rear direction are formed in the floor 301, and a plurality of replaceable battery units BT3 are installed in the recess portions 302. The battery unit BT3 is elongated in the front to rear direction, and is stored in a space between the long rails 320 that move a front seat FS3 and a rear seat RS3. In each of the recess portions 302, two battery units BT3 are arranged in the front to rear direction.

The lid 321 that also functions as a floor material is provided above each of the battery units BT3, and by opening the lid 321, the battery unit BT3 can be taken out. By disposing the battery unit BT3 between the long rails 320, the battery unit BT3 can be replaced without removing the long rails 320.

In addition, a length of the battery unit BT3 in the front to rear direction is set to be approximately half that of the long rail 320. Therefore, as shown in FIG. 26A, by moving the front seat FS3 and the rear seat RS3 to a front of the vehicle and opening the lid 321 disposed on a rear side of the vehicle V3, the battery unit BT3 disposed on the rear side can be replaced.

In addition, as shown in FIG. 26B, by moving the front seat FS3 and the rear seat RS3 to a rear of the vehicle and opening the lid 321 disposed on a front side of the vehicle V3, the battery unit BT3 disposed on the front side can be replaced.

In the present embodiment, regarding the battery units BT3, the two battery units BT3 divided in the front to rear direction are arranged, but this is merely an example. Three or more divided battery units BT3 may be disposed.

### Fourth Embodiment

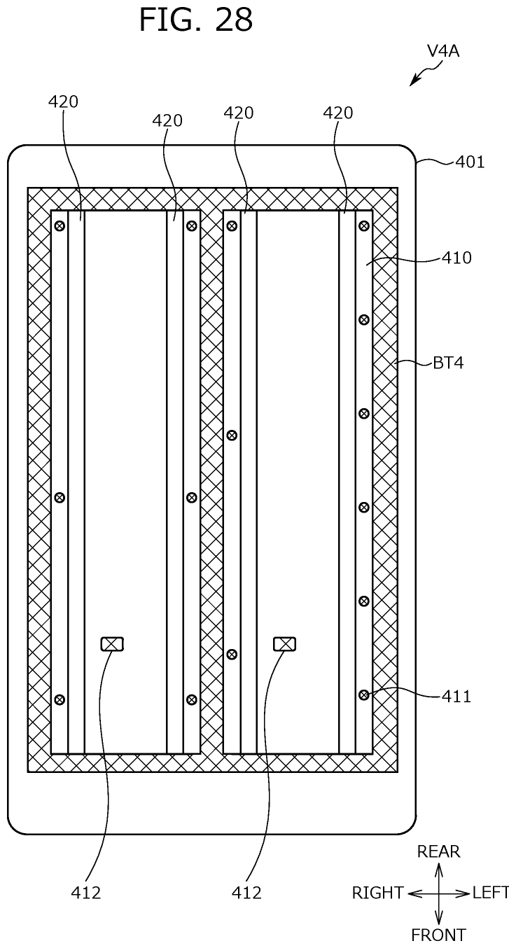

Next, a fourth embodiment of the present invention will be described using FIGS. 27A to 29B. The fourth embodiment relates to a vehicle in which a battery is placed under a floor.

In electric vehicles, reducing unevenness of rails or unevenness of foot brackets as much as possible is a problem in order to implement a flat floor. In a vehicle V4 of the present embodiment, in order to solve this problem and to secure a distance (head clearance) from the head of an occupant seated on a vehicle seat to a roof, as shown in FIG. 27A, long rails 420 are embedded and integrated into a battery BT4 under the floor (second floor 402). Since a flat surface is formed on the second floor 402, a vehicle interior space that looks wide can be achieved, and the head clearance can be secured.

In order to form the flat surface on the second floor 402, as shown in FIG. 27B, a rail mounting bracket 410 having the long rails 420 embedded therein may be provided.

In the related art, in a case where a platform architecture changes, it is necessary to change a frame and other configurations for each vehicle model. Since the rail mounting bracket 410 in which the long rails 420 are embedded is used, even in a case where positions of mounting points 411 to which the rail mounting bracket 410 is mounted change depending on the vehicle model, the long rails 420 can be mounted by changing only positions of holes of the mounting points 411. That is, there is no need to change a structure of a frame above the long rail 420, and any vehicle model can be handled with minimal changes.

In addition, by changing a shape of the rail mounting bracket 410, it is possible to create necessary unevenness for the vehicle interior space. There is no need to change a platform depending on the vehicle model. For example, in a case where an opening portion 412 is required for an intake port or the like, a hole may be formed in the rail mounting bracket 410.

In addition, considering synchronization of the long rails 420, it is better in terms of quality to form holes (mounting points 411) for fastening to the vehicle body frame after joining the rail mounting bracket.

In addition, although the vehicle body frame is present under the rail mounting bracket 410, it is difficult to eliminate the unevenness of the floor using only the vehicle body frame. By providing the rail mounting bracket 410, it is possible to enable the floor to be flat. When the floor is flat, a floor carpet can be flat, and a vehicle owner can dress up the vehicle by using a ready-made floor carpet.

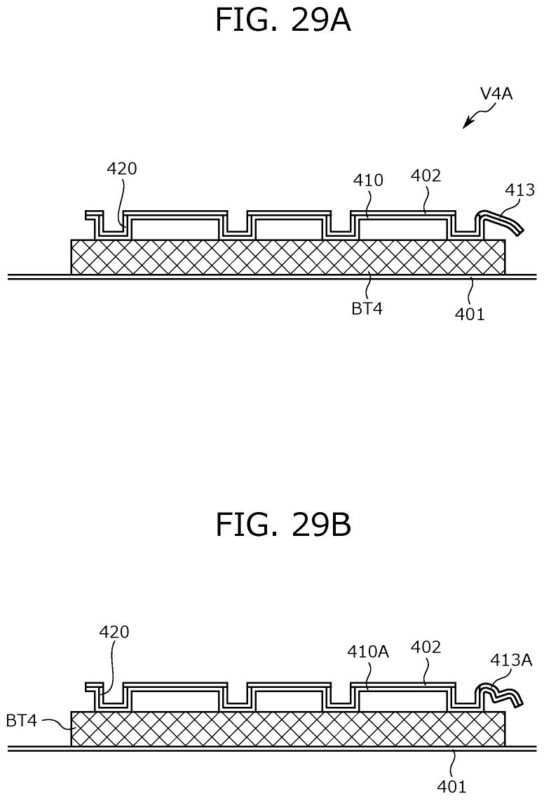

In addition, depending on a floor shape of the vehicle, there are cases where inclined surfaces are provided on right and left sides of right and left floors toward doors such as sliding doors in consideration of getting-on/off properties. As shown in FIG. 29A, an inclined portion 413 is provided on a side portion of the rail mounting bracket 410, the inclined portion 413 can be changed to match the vehicle for setting without changing the shape of the floor.

This inclined portion is not limited to an inclined surface that is inclined in a certain direction, but a shape of the inclined portion may be changed according to getting-on/off properties and usage as shown by an inclined portion 413A of a rail mounting bracket 410A shown in FIG. 29B. Since the inclined portion is separate from the vehicle body frame, the shape can be easily changed.

### Fifth Embodiment

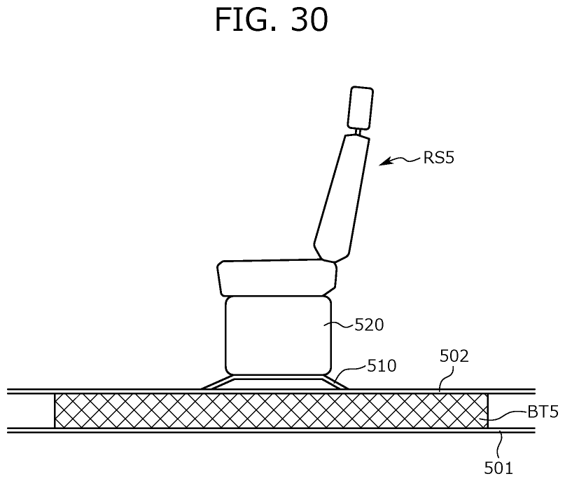

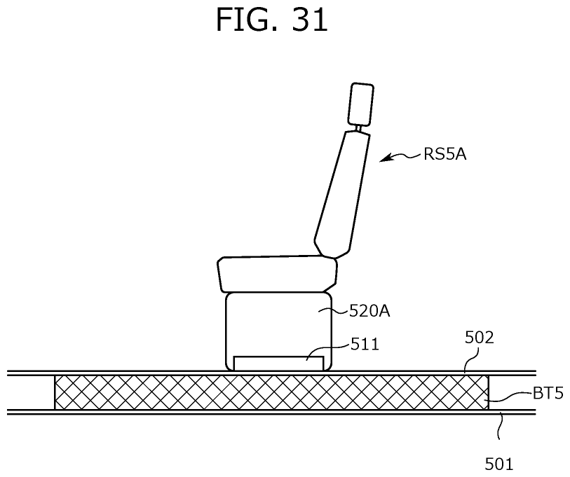

Next, a fifth embodiment of the present invention will be described using FIGS. 30 and 31. The fifth embodiment relates to a vehicle seat in which a battery is disposed on a lower side.

In electric vehicles, since a battery is disposed under a floor, there are cases where heat from the battery is transferred to the vehicle seat due to heat dissipation from the battery. Particularly in a case of a rear seat, the heat from the battery is easily transferred due to a close distance from the floor.

In a seat of the present embodiment, as shown in FIG. 30, a base 520 formed of expanded polypropylene (EPP) is used when a frame of a rear seat RS5 is disposed on a battery BT5.

In a case of disposing the base 520 made of EPP on the battery BT5, a foot bracket 510 for fixing is disposed. The foot bracket 510 and the base 520 made of EPP may be integrally molded.

By using the base 520 made of EPP, height adjustment can be achieved for each vehicle model, thereby improving exterior and interior designability. In addition, heat conduction to the rear seat RS5 due to heat dissipation from the battery BT5 can be effectively suppressed by the base 520 made of EPP.

In addition, in vehicles in the related art, there are cases where a floor to which a rear seat is mounted is provided with a reinforcing member for preventing buckling in order to prevent contact with high-voltage members.

A reinforcing member 511 for preventing buckling may be insert-molded into a base 520A made of EPP, as shown in FIG. 31. When mounting the base 520A made of EPP to a second floor 502, the reinforcing member 511 is fixed to the second floor 502.

By insert-molding the reinforcing member 511 into the base 520A, work of mounting the reinforcing member 511 to the vehicle seat RS5A can be omitted, thereby saving labor for assembling the vehicle.

The base 520A made of EPP can also be applied to the front seat and the middle seat. In the case of the front seat or the middle seat, the reinforcing member 511 having a U-shaped cross section may be attached below the lower rail.

### Sixth Embodiment

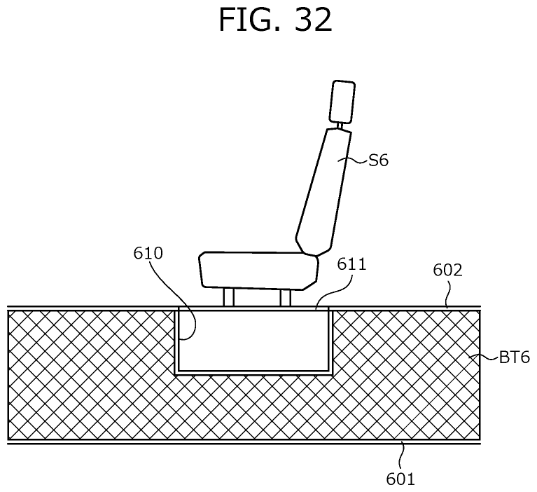

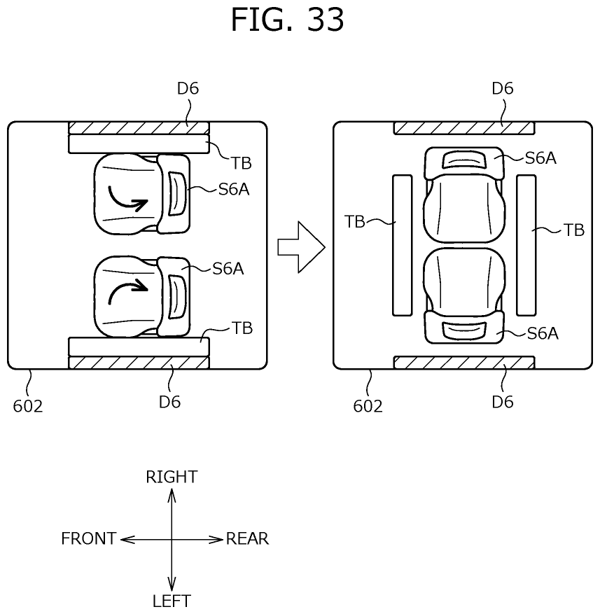

Next, a sixth embodiment of the present invention will be described using FIGS. 32 to 33B. The sixth embodiment relates to an electric vehicle provided with a battery.

In recent years, with the spread of electric vehicles, batteries are installed under a floor. Batteries are usually covered with a hard cover to be protected and fixed securely. Therefore, a vehicle seat S6 may be more securely fixed by extending legs of a vehicle seat provided on a floor, passing the legs through the floor (vehicle body frame, second floor), and fixing the legs to a case of a battery bT6. In this case, the vehicle body frame (second frame 602), battery BT, and the legs of the vehicle seat S6 may be fastened together.

In addition, with the spread of solid-state batteries, it is expected that the number of batteries provided under a seat cushion in an electric vehicle can be reduced. In this case, as shown in FIG. 32, a space can be formed below a vehicle seat S6 (more specifically, the seat cushion). This space may be provided with a lid portion and used as a storage portion 610 for other purposes. For example, the storage portion 610 is used to store a refrigerator or shoes.

The storage portion 610 as such may be provided in the battery BT6 having a recess portion as shown in FIG. 32. In addition, the battery BT6 may be disposed in the front to rear and right to left directions of the storage portion 610. A lateral slide device for laterally sliding the vehicle seat S6 or a rotating device for rotating the vehicle seat S6 may be put in the storage portion 610. In addition, the storage portion 610 may be provided with a lid portion 611 that also serves as a floor seat.

In addition, in vehicles in the related art, a relatively thick door panel is formed, and when a vehicle seat is rotated to be changed in direction, there are cases where the vehicle seat and the door panel interfere with each other.

Therefore, in a vehicle V6 of the present embodiment, as shown in FIG. 33, a part of a door panel D6 is configured to be removable as a table TB. When a vehicle seat S6A is rotated, the table TB, which is a part of the door panel D6, is removed to reduce a thickness of the door panel D6, thereby increasing a width of the vehicle interior space. As a result, the vehicle seat S6A and the door are prevented from interfering with each other when the seat is rotated.

The removed table TB can be used as a side table as shown on a right side of FIG. 33 after rotating the vehicle seat SA6.

### Seventh Embodiment

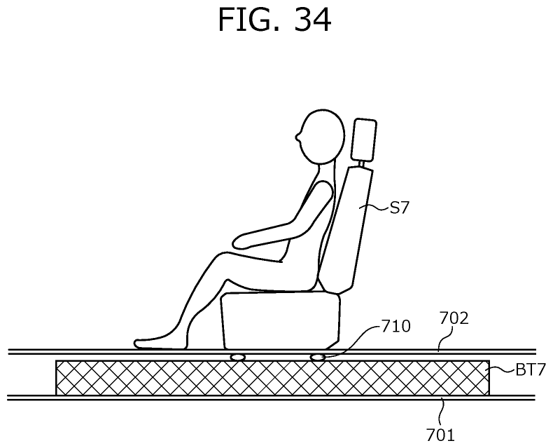

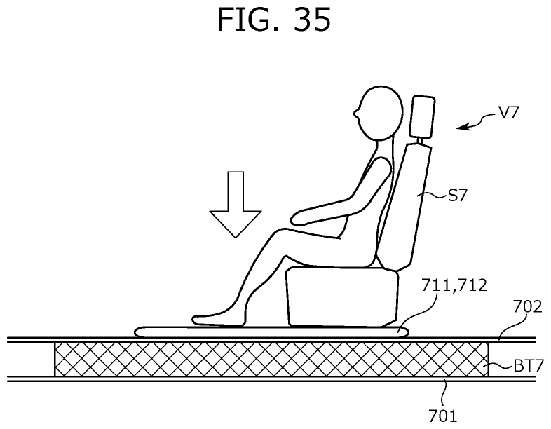

Next, a seventh embodiment of the present invention will be described using FIGS. 34 and 35. The seventh embodiment relates to a vehicle provided with a battery under a floor.

In gasoline-powered vehicles, no batteries are disposed under the floor, and a vehicle seat provides safe and comfortable sitting when moving. On the other hand, in recent years, with the spread of electric vehicles, there is a need for large-capacity batteries, leading to batteries being disposed under a floor. However, there are cases where batteries burn due to an impact, and it is necessary to further improve strength and rigidity to protect the batteries. In particular, in a case where a flip-up type seat is provided, a strong load may be applied to the batteries under the floor when getting on or off the vehicle, and it is necessary to protect the batteries from the impact when the seat is flipped up.

In addition, with the spread of electric vehicles, there has been a diversification in the way occupants spend the vehicle cabin spaces, and the recent health trends have created a demand for opportunities to exercise during travel time. As the way vehicle cabin space is used changes, there are also requirements to support seated occupants and protect batteries from vibrations and impacts caused by occupants exercising inside the vehicle cabin, which requires further improvements in strength and rigidity.

In a flip-up type vehicle seat, in a case where an input torque around a rotating hinge is set to a large value, the seat will flip up with great force, resulting in a large impact on the floor.

In a vehicle V7 of the present embodiment, an attenuation damper is provided to reduce an impact on a battery BT7, thereby suppressing a speed when the seat flips up.

In addition, when a vehicle seat S7 that has been flipped up is lowered forcibly to be locked in order to return the vehicle seat S7 to a seating mode, an impact on a second floor 702 also increases. Therefore, the attenuation damper is provided to suppress an impact load during locking.

In addition, as shown in FIG. 34, a vibration isolating material or a shock absorbing material 710 may be provided between the second floor 702 and the battery BT7 so that the impact from the second floor 702 is not directly transmitted to the battery BT7. Accordingly, the battery BT7 can be protected from the impact.

In addition, as shown in FIG. 35, a reinforcing panel may be provided on a floor surface that is stepped on by the occupant when the occupant exercises. That is, the reinforcing panel for strengthening the floor is installed in a place where occupants are expected to exercise. Alternatively, a sensor may be disposed in a reinforced portion to allow the occupants to exercise only in the portion where the sensor is disposed. A place where a reinforcing panel 711 is provided is not limited to the place where occupants are expected to exercise, and may be disposed at a place where the seat is mounted and removed without sliding rearward to allow occupants to get on and off the vehicle. The battery can be protected by reinforcing the floor used for getting on and off the vehicle.

In addition, in the related art, a floor mat disposed on the floor has been required to have combustibility, stain resistance, and an anti-slip function. Therefore, as a material of the floor mat, rubbers or fibers such as woven fabric have been used, and a single layer or a stack of layers thereof forms the floor mat.

On the other hand, in recent years, with the trend toward electrification, there has been a demand for improvements in insulation, sound absorption, and vibration damping properties in order to prevent electrical leakage and to suppress transmission of vehicle body vibrations.

Instead of the reinforcing panel 711 shown in FIG. 35, a floor mat 712 having insulation and sound absorbing properties may be disposed. The floor mat 712 of the present embodiment is configured to increase insulation resistance and absorb vibration by backing a rubber component with a resin.

By using the floor mat 712, it is possible to take measures against electrical leakage in an emergency, and it is possible to suppress transmission of vehicle body vibration to the occupants.

### Eighth Embodiment

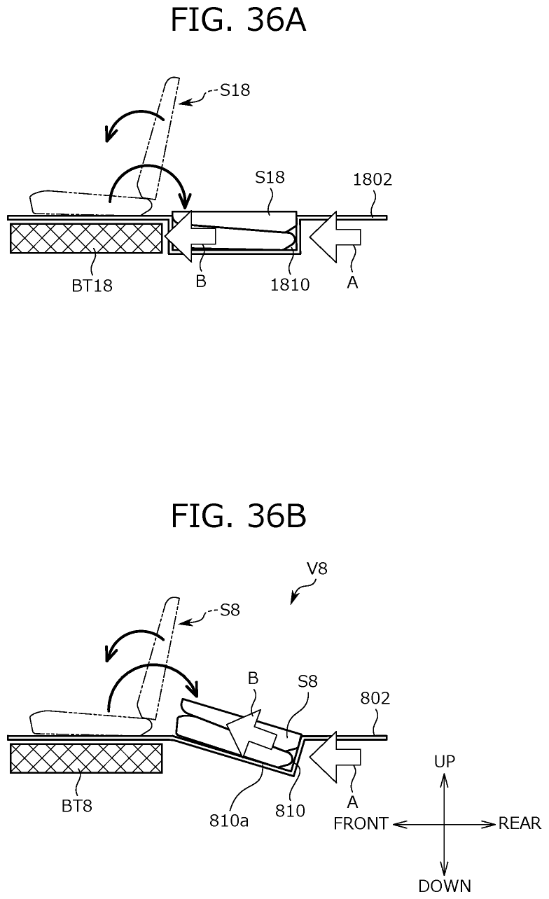

Next, an eighth embodiment of the present invention will be described using FIGS. 36A and 36B. The eighth embodiment relates to a vehicle provided with a vehicle seat that dives down toward the rear.

In the related art, a vehicle seat S18 that dives down toward the rear of the vehicle is formed to be storable in a storage recess portion 1810 of which a bottom portion is parallel to a floor 1802, for example, as shown in FIG. 36A.

However, in electric vehicles, a battery BT18 is disposed under the floor and is in series with the vehicle seat S18 in the stored state. Therefore, when an impact is applied from behind as shown by arrow A in FIG. 36A, the impact is transmitted to the battery BT18 via the vehicle seat S18, potentially causing damage to the battery BT18.

In a vehicle V8 of the present embodiment, as shown in FIG. 36B, a storage recess portion 810 with an inclined bottom portion 810a is formed to store the folded vehicle seat S8. By forming the storage recess portion 810 as described above, the folded vehicle seat 8 will move in an arrow B direction in FIG. 36B even if an impact is applied from the rear (arrow A in FIG. 36B), so that the impact can be dissipated obliquely upward. Direct transmission of the impact to the battery BT8 under the floor is suppressed, and the battery BT8 can be protected.

In the storage recess portion 810 with the inclined bottom portion 810a, not only the vehicle seat S8 in the folded state but also other stored items may be stored in the storage recess portion 810 in a case where the vehicle seat 8 is in a seatable state. Since the bottom portion 810a is inclined, even in a case where an impact is applied from behind, the stored items can be moved obliquely upward, and the battery BT8 can be protected from the impact.

### Ninth Embodiment

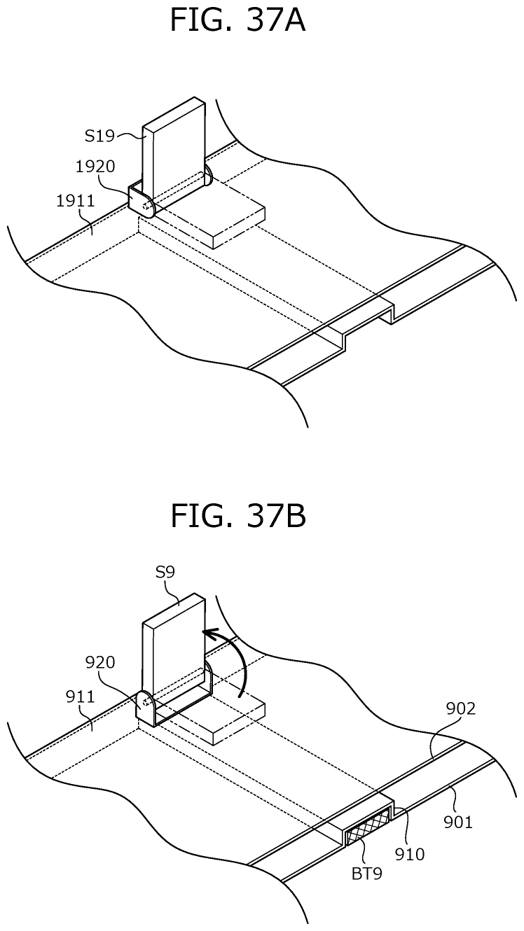

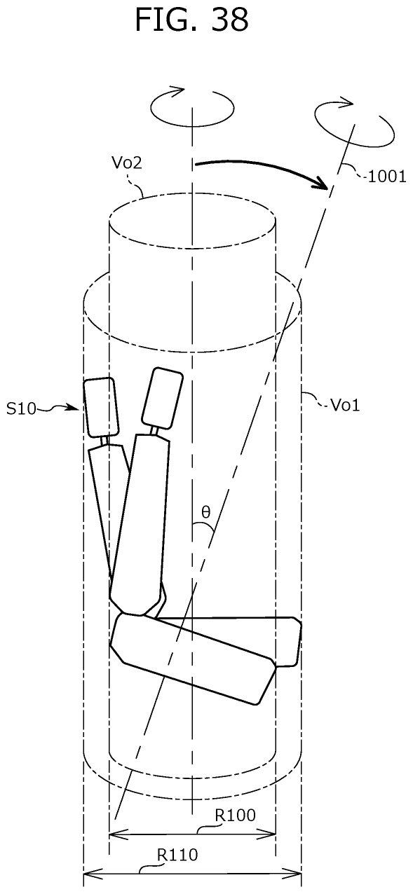

Next, a ninth embodiment of the present invention will be described using FIGS. 37A and 37B. The ninth embodiment relates to an electric vehicle V9 provided with a vehicle seat S9 with a flip-up mechanism.

In the related art, vehicles have been known in which rear seats are provided with a flip-up mechanism in order to expand a space such as a luggage compartment. A mounting portion 1912 of such a flip-up type seat S19 is fixed to a side wall 1911 or a door panel of a side portion of the vehicle, as shown in FIG. 37A.

The vehicle seat S9 of the present embodiment is a flip-up type seat, and is provided in the electric vehicle V9. As shown in FIG. 37B, a floor is constituted by a first floor 901 and a second floor 902 disposed above the first floor 901, and in the first floor 901, a protrusion portion 910 protruding upward and extending in a seat width direction is formed similarly to the protrusion portion of the first embodiment. In addition, a battery BT9 is disposed under the protrusion portion 910.

In the present embodiment, a mounting portion 920 of the flip-up type vehicle seat S9 is mounted to the protrusion portion 910 under which the battery BT9 is disposed. Providing the mounting portion 920 on the protrusion portion 910 improves rigidity of the first floor 901, and accordingly, the battery BT9 can be protected.

### Tenth Embodiment

Next, a tenth embodiment of the present invention will be described using FIG. 38. The tenth embodiment relates to a vehicle seat that is installed in a vehicle such as an electric vehicle and can be changed in direction.

In the related art, in vehicle seats that rotate on a rotation axis perpendicular to a floor, a volume occupied during rotation is determined by a longest portion of a cushioned seat, such as a size of a diagonal of a seat cushion and the degree to which a seat back protrudes outward. Therefore, when the seat is rotated, there is a possibility that the seat interferes with an occupant or a door depending on a shape of the seat.

In a rotatable conveyance seat S10 of the present embodiment, as shown in FIG. 38, a rotation axis 1001 is shifted and tilted when rotating, thereby reducing a volume Vo2 occupied when the conveyance seat S10 rotates. That is, a diameter R100 of the volume Vo2 occupied in the case where the rotation axis 1001 is tilted is shorter than a diameter R110 of a volume Vo1 occupied in a case where the rotation axis 1001 is not tilted, so that interference with other components is suppressed.

At this time, a tilt angle θ may be smaller than an angle that forms a desired space and smaller than an angle that allows stress-free rotation. By tilting the rotation axis 1001, the volume Vo2 occupied during rotation can be reduced, and interference with the occupant and other components can be suppressed.

### Eleventh Embodiment

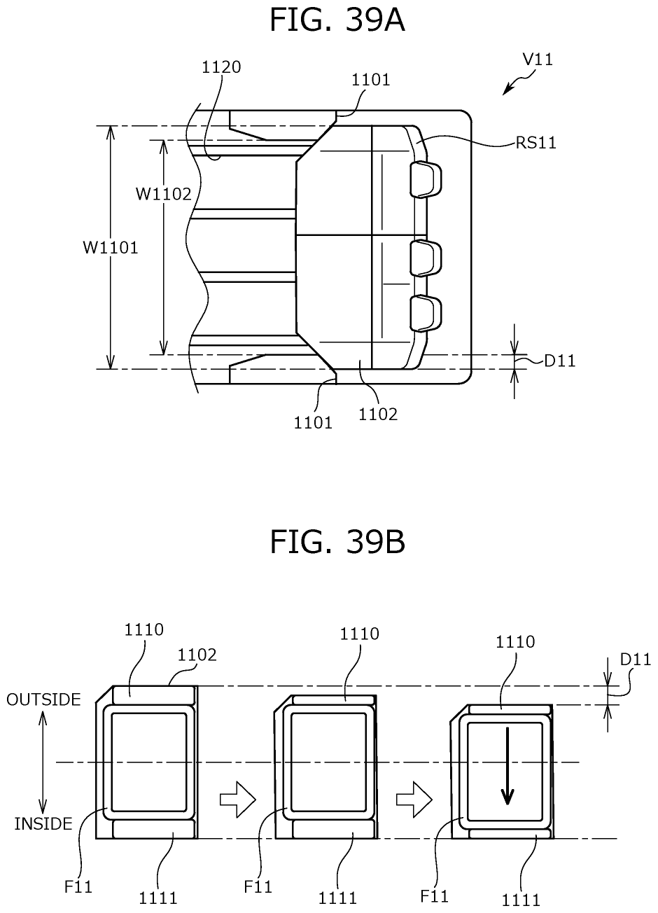

Next, an eleventh embodiment of the present invention will be described using FIGS. 39A to 41. The eleventh embodiment relates to a vehicle seat that is movable in the front to rear direction by a slide mechanism.

FIG. 39A is a top view of a rear seat RS11 installed in a vehicle V11. In a case of moving the rear seat RS11 forward on long rails 1120, a width W1101 of a seat cushion is longer than a distance W1102 between wheel houses 1101, and it is difficult for the rear seat RS11 to move due to an interference with the wheel houses 1101.

An object of the rear seat RS11 (vehicle seat) of the present embodiment is to provide a movable vehicle seat even in a case of a width is narrowed due to the wheel houses 1101 or the like.

As shown in FIG. 39B, the rear seat RS11 of the present embodiment has an air bladder (air cell 1110) provided outside a skeleton (cushion frame F11) of a seat cushion 1102 to support a skin and the like. A pipe (not shown) for feeding air is connected to the air cell 1110, and the air cell 1110 can be expanded or contracted by supplying or discharging air. That is, by contracting the air cell 1110, the length W1101 of the rear seat RS11 in the seat width direction can be shortened, as shown in FIG. 39B.

When moving the rear seat RS11 forward, the air cell 1110 is contracted to narrow the seat width, whereby it is possible to move the rear seat RS11 forward.

In addition, an air cell 1111 may be provided not only on an outside of the rear seat RS11 but also on an inside of the rear seat RS11. By sliding the seat cushion 1102 in the seat width direction, the seat width W1101 can be further narrowed by an extent to which the air cell 1111 provided on the inside is contracted. Accordingly, the rear seat RS11 can be moved in the front to rear direction without interfering with the wheel houses 1101 or the like. After the movement, air can be sent into the air cells 1110 and 1111 to restore the original seat width W1101.

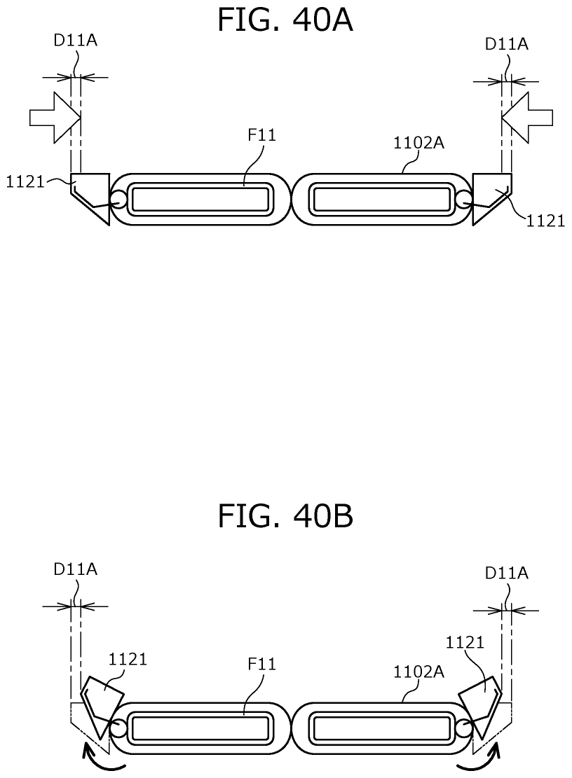

In addition, as shown in FIG. 40, a support member 1121 having a rotation axis (rotation hinge) may be configured on the outside of the seat cushion.

When moving the rear seat RS11 forward, the seat width can be narrowed by rotating the support member 1121 and folding the support member 1121.

In addition, similar to the vehicle seat shown in FIG. 39, the air cell 1111 may be provided on the inside of the seat cushion 1102, and the seat width may be further narrowed by sliding the seat cushion 1102 toward the inside of the seat.

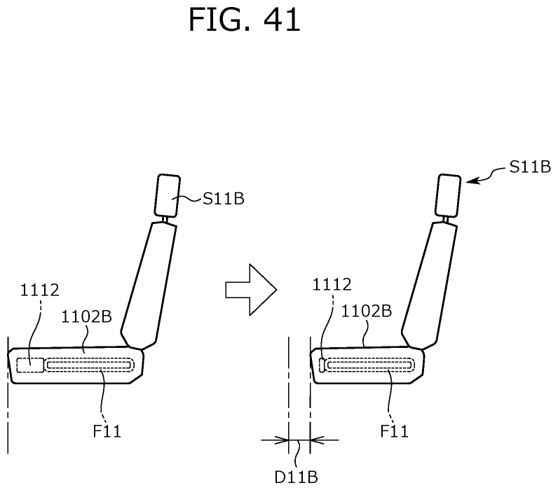

In addition, in a case of changing a direction of a vehicle seat S11B in the front to rear direction by rotating the vehicle seat S11B around an axis in the vertical direction, there are cases where the knees of the seated occupant interfere with other seats, resulting a difficulty in rotation. Therefore, as shown in FIG. 41, an air cell 1112 may be provided in the front of the vehicle seat S11B, and when rotating the vehicle seat S11B, the air cell may be contracted to shorten a length of a seat cushion 1112B in the front to rear direction. The knees of the seated occupant can be moved toward the inside of the seat, and interference with other vehicle seats can be suppressed.

### Twelfth Embodiment

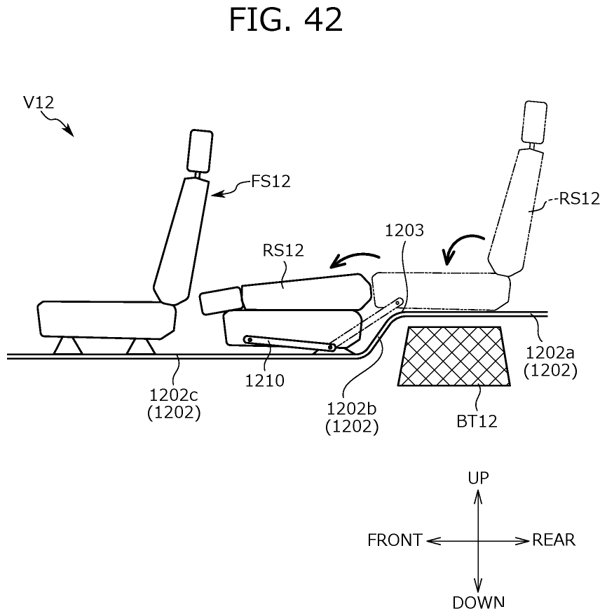

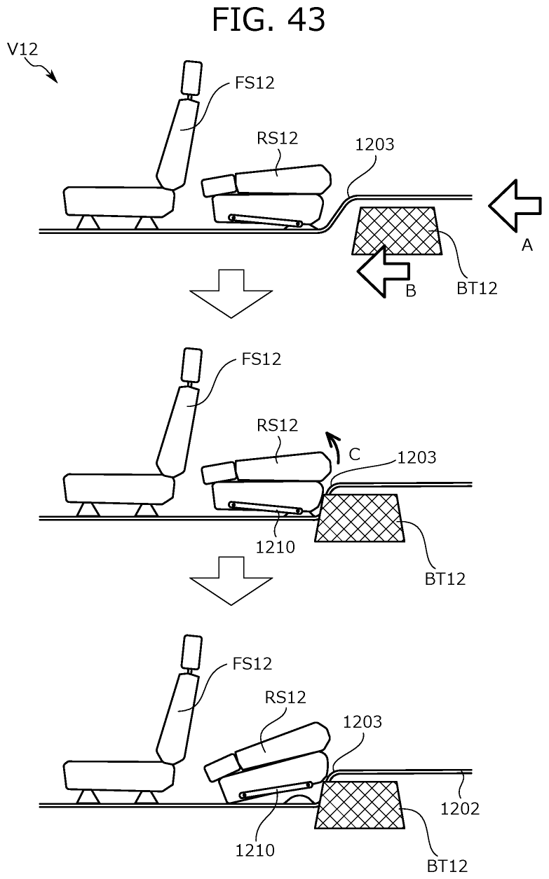

Next, a twelfth embodiment of the present invention will be described using FIGS. 42 and 43. The twelfth embodiment relates to a vehicle seat that can dive down toward the front.

In the related art, a vehicle seat is known in which a floor and a seat are connected via a link and the vehicle seat can dive down toward the front.

A rear seat RS12, which is a vehicle seat of the present embodiment that can dive down, is provided on a floor panel 1202 of a vehicle V12, as shown in FIG. 42. The floor panel 1202 of the vehicle V12 is constituted by an upper floor 1202a and a lower floor 1202c that is continuous through a stepped portion extending downward from a front end of the upper floor 1202a. The rear seat RS12 of the present embodiment is configured so that a seat cushion is located in front of the stepped portion 1202b (above the lower floor 1202c) when the rear seat RS12 dives down.

In an electric vehicle, there are cases where a battery BT12 and a motor are disposed under the upper floor 1202a. In the case of such a configuration, when a rear collision occurs while the seat is in a dive-down state, the battery moves forward and collides with the seat in the dive-down state at the fixed position, potentially causing damage.

In the dive down type rear seat RS12 of the present embodiment, a link 1210 is used for engagement between the seat cushion and the lower floor, and the link 1210 is configured to disengage when an impact is received from the rear. In addition, a lower surface of the seat cushion is formed in a curved shape so that the seat cushion can ride on a pedestal 1203.

Therefore, in the dive-down state, the link 1210 (bolt portion) of the rear seat RS comes off and the rear seat RS12 rides on the pedestal of the floor, creating a space between a front seat FS12 and the rear seat RS12.

An operation of the rear seat RS12 when a rear collision occurs will be described using FIG. 43. As shown in an upper part of FIG. 43, when a rear collision (arrow A direction) occurs, the battery BT12 disposed under the floor panel 1202 is pushed forward (arrow B direction). Then, as shown in a middle part of FIG. 43, the battery BT12 hits the stepped portion 1202b of the floor, and the stepped portion 1202b of the floor is deformed. At this time, the engagement of the link 1210 is released. When the engagement of the link 1210 is released, the rear seat RS12 can ride on the stepped portion 1202b of the floor, as shown in a lower part of FIG. 43, so that application of a strong impact to the battery BT12 can be avoided.

A shape of the battery BT12 is formed such that the battery BT12 first hits a center of the rear seat in the right to left direction (a position of a seat cushion frame excluding a frame extending in the front to rear direction) when the battery BT12 moves forward due to an impact or the like. For example, a protrusion portion protruding toward the stepped portion 1202b of the floor may be provided at a center portion of the battery BT12.

The rear seat RS12, which is the dive-down seat of the present embodiment, is configured to release the engagement of the link and collapse in the front to rear direction when a load is applied from behind in the dive-down state. When the rear seat is interposed between the stepped portion of the floor and the front seat due to the collapse of the floor caused by a collision, a collision load can be absorbed by the rear seat, thereby suppressing damage to the battery BT12, for example.

One that is disposed under the upper floor 1202a is not limited to the battery BT12, but may also be a motor (not shown). In addition, such a configuration of the dive down seat can be applied not only to rear collisions but also to front collisions and side collisions.

### Thirteenth Embodiment

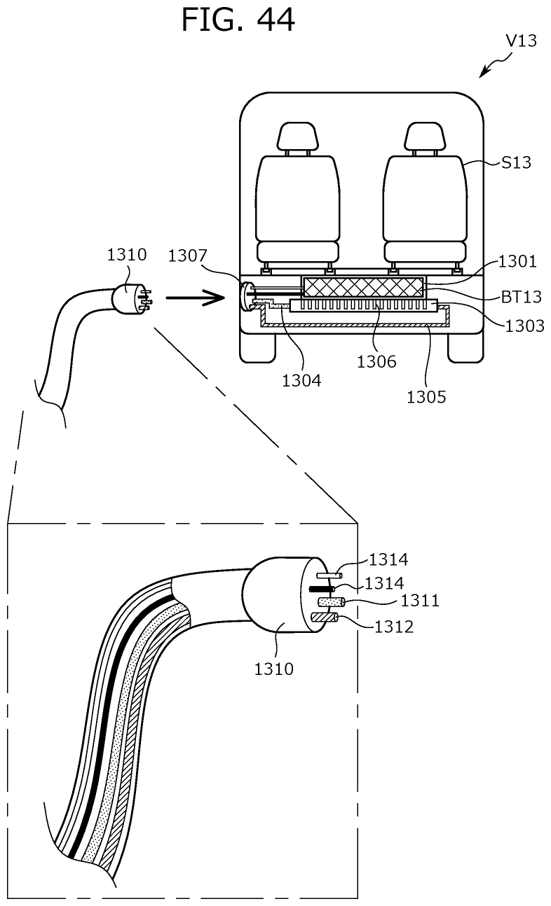

Next, a thirteenth embodiment of the present invention will be described using FIG. 44. The thirteenth embodiment relates to a charging plug connected to a battery.

In the related art, an electric vehicle is charged by inserting a charging plug into a charging insertion port of the vehicle. In order to shorten a charging time, it is necessary to increase electric power sent from the charging plug. However, increasing the electric power also increases the amount of heat generated. Batteries that have generated heat need to be cooled down, but it has been difficult to cool the batteries sufficiently with air cooling.

Therefore, it is desirable to perform liquid cooling on the batteries for safe and effective rapid charging, and in the charging plug of the present embodiment, there is an attempt to perform rapid charging safely while cooling the batteries by replacing a refrigerant used for cooling the batteries during charging.

In addition to power source terminals 1314, a charging plug 1302 of the present embodiment is provided with a separate plug for replacing a refrigerant of a refrigerant cooler that cools a battery BT13 installed in a vehicle V13. A discharge port 1311 and a recovery port 1312 for supplying and refluxing the refrigerant are provided, and by supplying and refluxing the refrigerant from a charger side at the same time as charging, it is possible to cool the battery BT13 and perform rapid charging.

As shown in FIG. 44, a battery case 1301 is installed below a seat S13 in the vehicle V13, and a battery cooling layer 1303 is provided under the battery case 1301. A pre-battery cooling refrigerant transport pipe 1304 is connected to the battery cooling layer, and when the charging plug 1310 is inserted into an insertion port 1307, the refrigerant is supplied from the discharge port on a battery refrigerant discharge side.

The battery cooling layer 1303 is provided with a heat sink 1306 for cooling the battery, and heat transferred from the battery case can be efficiently cooled using the refrigerant. A high temperature refrigerant transport pipe 1305 through which the refrigerant that has become a high temperature after cooling the battery is transported is connected to the battery cooling layer 1303. The high temperature refrigerant transport pipe 1305 extends to the insertion port 1307 and can recover the refrigerant that has become a high temperature from the recovery port.

The charging plug is provided with the power source terminals 1314 for the battery and the discharge port 1311 and the recovery port 1312 below the power source terminals 1314 for the refrigerant. In a case where the vehicle is provided with both a normal charging insertion port and a rapid charging insertion port, the discharge port 1311 and the recovery port 1312 are provided below at least the rapid charging insertion port.

By discharging and recovering the refrigerant at the same time as charging and circulating the refrigerant, the battery BT13 is efficiently cooled, so that charging with large electric power becomes possible, leading to a reduction in the charging time.

### Fourteenth Embodiment

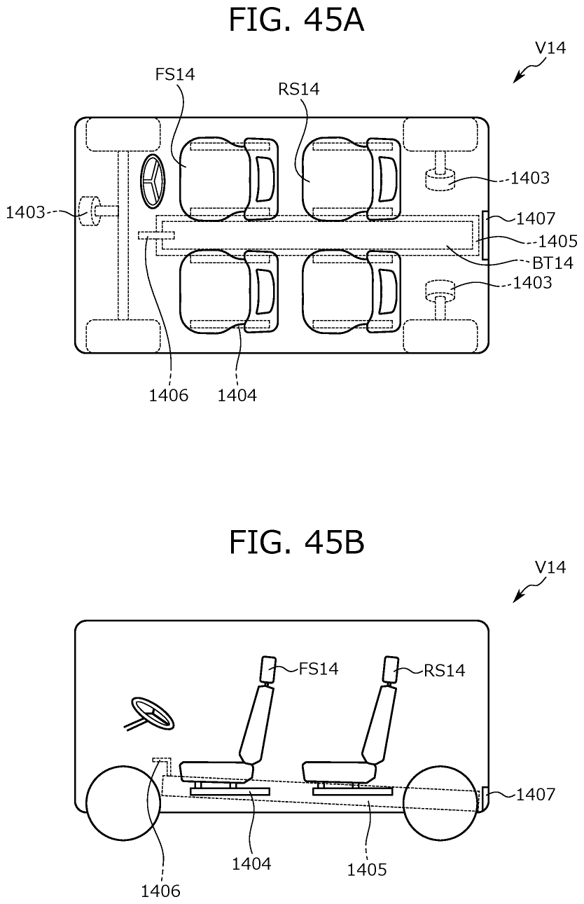

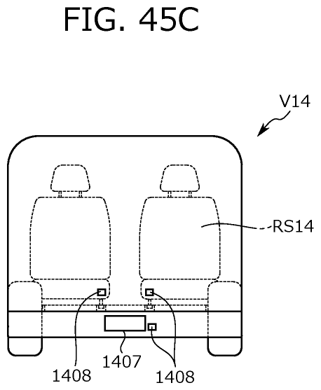

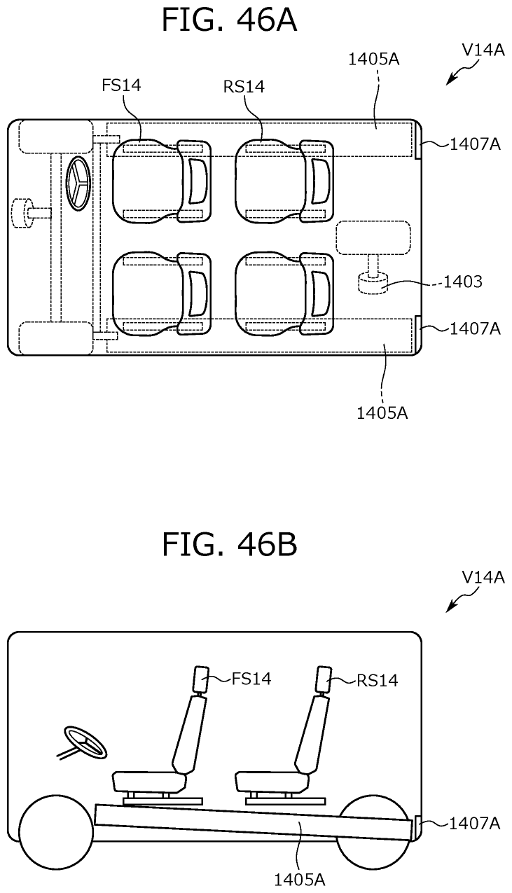

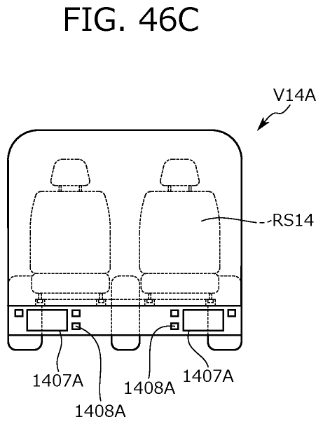

Next, a fourteenth embodiment of the present invention will be described using FIGS. 45A to 46C. The fourteenth embodiment relates to an electric vehicle with a replaceable battery.

An electric vehicle in the related art is charged by connecting a charging plug to a battery installed in the vehicle, which causes problems such as time-consuming charging. On the other hand, although it is possible to replace the battery with a battery that has been already charged, the battery is heavy and difficult to replace easily.

In view of the above problems, an object of the present embodiment is to provide an electric vehicle that enables easy battery replacement.

As shown in FIG. 45A, an electric vehicle V14 of the present embodiment includes motors 1403 and a plurality of vehicle seats S14 (front seats FS14 and rear seats RS14) disposed on a floor. Rails 1404 are provided below the vehicle seat S14 so that the vehicle seat S14 can be moved in the front to rear direction. A battery storage tunnel 1405 in which a battery BT14 for replacement is stored is provided between the rails 1404 to pass between the rails 1404. The battery storage tunnel 1405 may be disposed to pass between the vehicle seats S14.

A battery lock 1406 for fixing the inserted battery BT14 is provided at a front end portion of the battery storage tunnel 1405. The battery lock 1406 also serves as a connector for energization, so that the inserted battery BT14 can be fixed and energized at the same time.

The battery storage tunnel 1405 is provided to be inclined slightly downward at a rear. By inclining the battery storage tunnel 1405, the battery in the battery storage tunnel 1405 comes down under its own weight at the time of replacement, and the battery can be easily taken out.

In addition, by providing a connector for battery energization on an upper portion of the battery storage tunnel 1405, in the event of water leakage, water that has infiltrated into the battery storage tunnel 1405 can be discharged by its own weight. It becomes possible to insert and remove the battery BT14 without bringing an end portion of the battery BT14 into contact with the ground.

In addition, the battery BT14 may have an arc-shaped cross section on an upper side. With the arc-shaped upper side, even in a case where the battery BT14 is flooded, water can flow downward under its own weight and be discharged from the inclined battery storage tunnel 1405.

The battery storage tunnel 1405 is configured to insert the battery BT14 through an insertion hole 1407 provided at the rear of the vehicle. The battery BT14 may be inserted manually, but it is also possible to automatically replace the battery BT14 using mechanical measures such as a robot. At this time, as shown: in FIG. 45C, when a position recognition mark 1408 for battery replacement is provided around the insertion hole 1407, an exact position of the insertion hole can be automatically recognized, and the battery BT14 can be easily replaced.

Another example of an electric vehicle 1401 is shown in FIGS. 46A to 46C. In the electric vehicle 1401 shown in FIG. 45A, one battery storage tunnel is provided in a center. However, in an electric vehicle 1401A shown in FIG. 46A, rear wheels are disposed at a center and the electric vehicle 1401A has three wheels, so that battery storage tunnels 1405A are disposed on both right and left sides of a vehicle body. A configuration of the battery storage tunnel 1405A is similar to that shown in FIG. 45A, so that a detailed description will be omitted. By providing the battery storage tunnels 1405A on both right and left sides of the vehicle body, more batteries BT14 can be installed, and a cruising distance can be extended.

### Fifteenth Embodiment

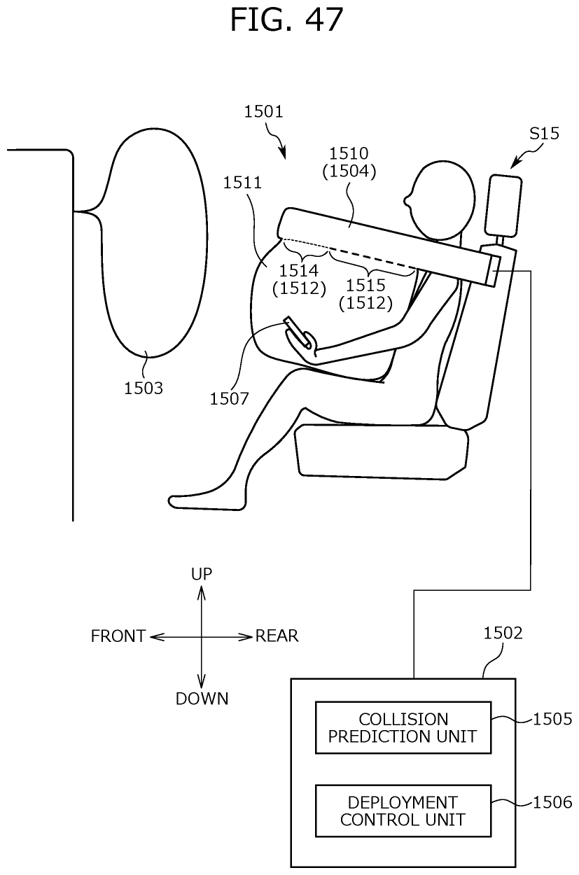

Next, a fifteenth embodiment of the present invention will be described using FIGS. 47 to 54. The fifteenth embodiment relates to an occupant protection device that appropriately protects an occupant when a collision is predicted.

JP 2021-37923 A discloses an occupant protection device including a main airbag device that protects an occupant in the event of a collision of a vehicle, a sub-airbag device that sweeps off the arm of the occupant, and a control unit that deploys a main airbag bag body after deploying a sub-airbag bag body when a collision is predicted.

Since the sub-airbag device is provided on a seating seat, even in a case where the seating seat is moved rearward by a seat slide device, the sub-airbag bag body can be deployed immediately when a collision is predicted, and the occupant can be appropriately protected without delaying the deployment of the main airbag bag body.

However, although JP 2021-37923 A discloses that the sub-airbag bag body is used to sweep off the arm of the occupant, a behavior of the sub-airbag bag body when deployed and a method of storing the sub-airbag bag body are not disclosed. Therefore, in the present embodiment, the behavior of the sub-airbag bag body and the storage method thereof are more specifically described, and an object is to improve protection performance for the occupant by appropriately deploying the sub-airbag bag body and sweeping off the arm of the occupant.

As shown in FIG. 47, an occupant protection device 1501 of the present embodiment includes a vehicle seat S15, a main airbag 1503, a sub-airbag 1504, a collision prediction unit 1505 for predicting a collision of a vehicle, and a deployment control unit 1506.

The vehicle seat 1502 is provided so that an occupant can be seated thereon and move in the front to rear direction of the vehicle. The main airbag 1503 is configured to deploy from the front of the vehicle toward the occupant when a collision of the vehicle is predicted by the collision prediction unit 1505.

The sub-airbag 1504 is stored in the vehicle seat 1502 and is configured to deploy toward the occupant when a collision is predicted.

The deployment control unit 1506 is configured to deploy the sub-airbag 1504 from the vehicle seat 1502 and thereafter deploy the main airbag 1503 in a case where a collision of a vehicle is predicted by the collision prediction unit 1505.

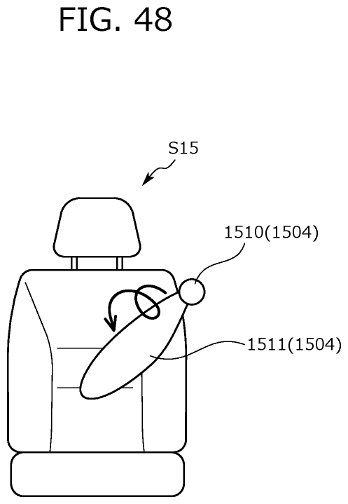

In addition, the sub-airbag 1504 is constituted by a first bag portion 1510 and a second bag portion 1511, as shown in FIGS. 47 and 48. The first bag portion 1510 and the second bag portion 1511 have a joint portion 1512 joined by adhesion or sewing.

The joint portion 1512 has a breaking portion 1514 and a non-breaking portion 1515, and the second bag portion 1511 is configured so that when the first bag portion is deployed by air injected into the first bag portion, the breaking portion 1514 breaks, and the air enters the second bag portion 1511 to deploy the second bag portion 1511.

At the time of a collision, when the occupant is holding a mobile terminal 1507 or the like, the sub-airbag 1504 is deployed, causing the arm of the occupant and the mobile terminal 1507 to be swung down. The mobile terminal 1507 or the arm of the occupant is prevented from being caught between the main airbag 1503 and the body of the occupant, so that the occupant can be appropriately protected.

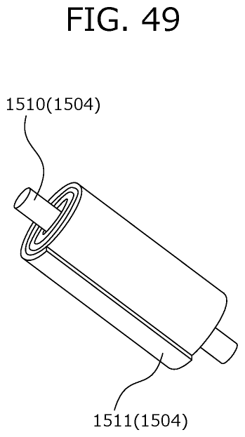

In a case of storing the sub-airbag 1504, the second bag portion 1511 is stored so as to wrap around the first bag portion 1510, as shown in FIG. 49. At this time, the breaking portion 1514 may be disposed on a tip side of the first bag portion 1510.

By storing the second bag portion 1511 in this manner, the sub-airbag 1504 can be efficiently stored and can be deployed to cause the arm of the occupant to be swung down.

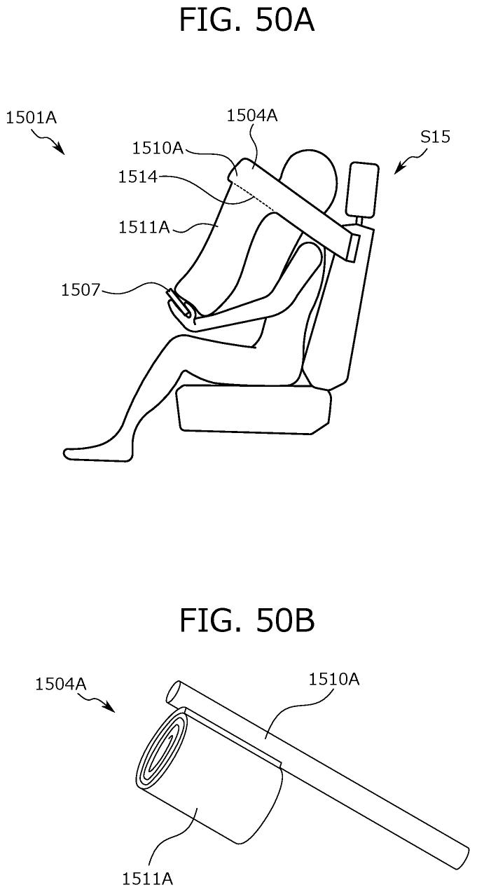

A second example of the sub-airbag 1504 will be described using FIGS. 50A and 50B. As shown in FIG. 50A, in a sub-airbag 1504A of the second example, a second bag portion 1511A is disposed at a tip portion of a first bag portion 1510. The second bag portion 1511A is stored by being wound clockwise from a tip thereof, and the tip of the first bag portion 1510A is disposed outside the tip of the wound second bag portion 1511A. By the storage in this manner, the sub-airbag 1504A can be stored efficiently.

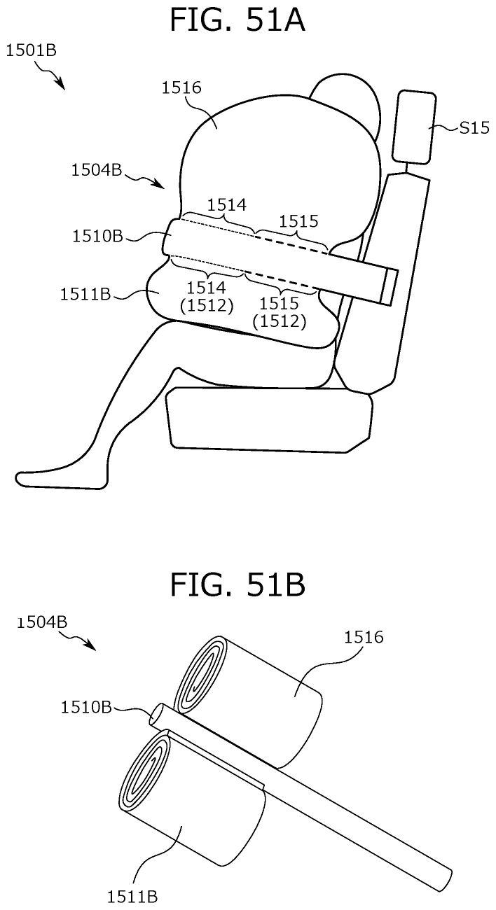

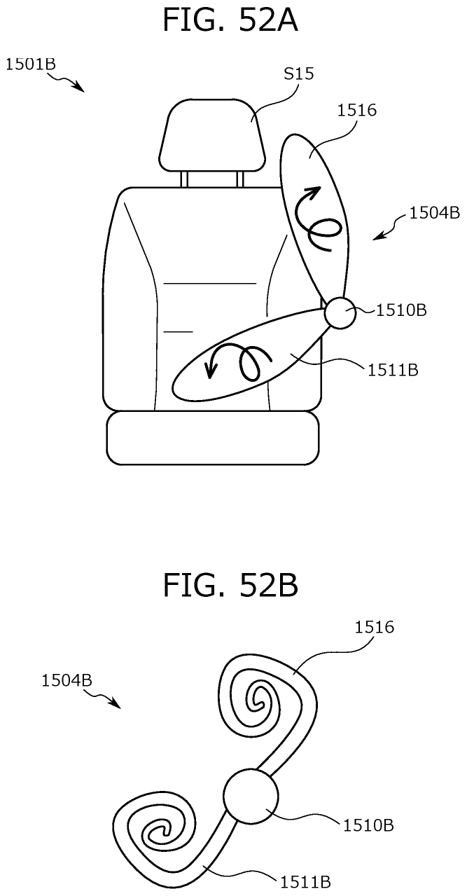

Next, a third example of the sub-airbag 1504 will be described using FIGS. 51A to 52B. As shown in a sub-airbag 1504B shown in FIG. 51A, a first bag portion 1510 may be provided with a third bag portion 1516 that deploys upward in addition to a second bag portion 1511B that deploys downward in the event of a collision.

At this time, the deployment control unit 1506 may control the second bag portion 1511C to be deployed after the first bag portion 1510C is deployed, and the third bag portion 1516 to be deployed after the second bag portion 1511C is deployed.

As shown in FIG. 51B, the second bag portion 1511B and the third bag portion 1516 are configured to be more compact when stored by winding the tips thereof. At this time, as shown in FIG. 52B, the second bag portion 1511B may be wound counterclockwise from the tip thereof, and the third bag portion 1516 may be stored clockwise.

At this time, a position at which the sub-airbag 1504 is stored is located below a storage position of the sub-airbag 1504 in the first example. By providing the third bag portion 1516, the head of the occupant can be protected.

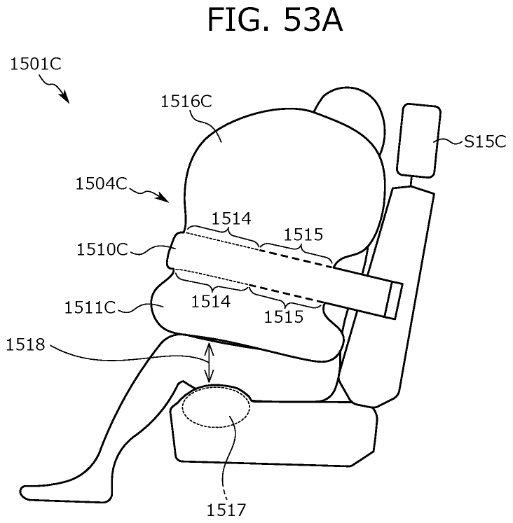

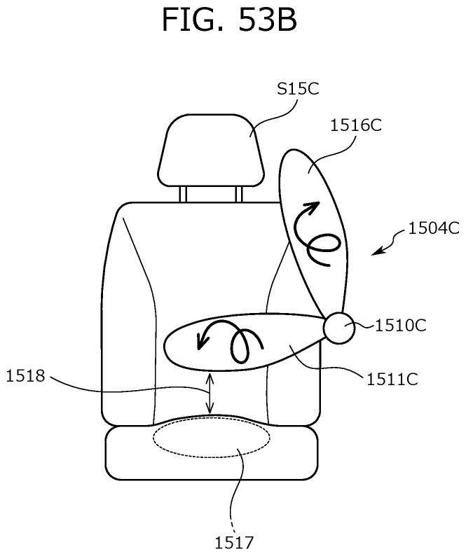

In addition, similarly to an occupant protection device 1501C shown in FIGS. 53A and 53B, a submarine airbag 1517 may be provided in a seat cushion of a vehicle seat S15C, separately from a sub-airbag 1504C. The submarine airbag 1517 may be disposed so that a portion of a second bag portion and a portion of the submarine airbag 1517 overlap in the up to down direction during deployment when viewed in a direction from the front of the vehicle. In addition, the submarine airbag 1517 may be configured so that when the submarine airbag 1517 is deployed, a gap is formed between a front end portion of a seat cushion 1502b and a second bag portion 1511C. By providing a gap 1518, excessive compression of body parts such as the legs and arms of the occupant can be suppressed by the second bag portion 1511C and the submarine airbag 1517.

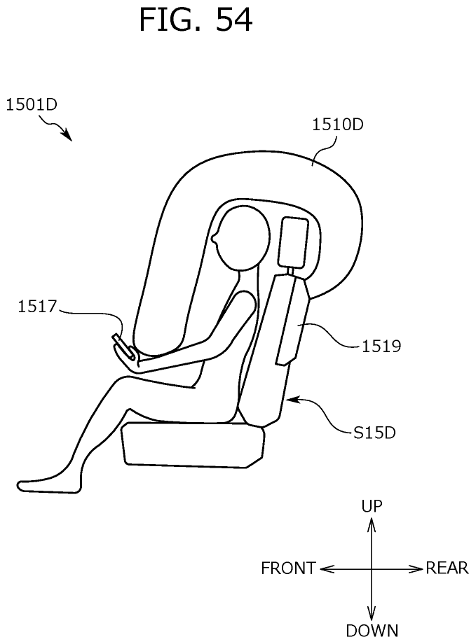

In addition, similarly to an occupant protection device 1501D shown in FIG. 54, a sub-airbag 1504D may be configured to deploy forward from an airbag storage portion 1519 provided on a back surface of a seat back. The sub-airbag 1504D can protect the head of the occupant while also sweeping off the arm of the occupant.

The first to fifteenth embodiments of the present invention have been described above using the drawings. As an example of the present invention, the electric vehicle and the vehicle seat installed therein have been adopted and the configuration examples thereof have been described. However, the present invention is not limited to the electric vehicle, and may also be applied to engine vehicles, hybrid vehicles including both a motor and an engine for traveling, and vehicles in which a battery and a fuel cell are installed as a power source. Furthermore, the present invention is not limited to ground conveyances with wheels, such as automobiles and trains and vehicle seats installed therein, and may also be applied to aircrafts and ships that move other than on the ground and conveyance seats installed therein.

### REFERENCE SIGNS LIST

### First Embodiment

V: vehicle
FL: vehicle body floor
FL1: first floor
FL2, FL2A: second floor
FL3: vehicle body bottom portion
BT: battery
S, SA: vehicle seat
FS: front seat
RS: rear seat
2: vehicle cabin
3: vehicle body
10: protrusion portion
11: rail support member
12, 12A: raising member
13: recess portion
14: recess portion
15: vehicle body structure portion
16: rotating device
17: recess portion
18: slit
20: long rail
21: lower rail
22: upper rail
23, 23A: airbag device
24, 24A: airbag
25: seat attachment/detachment mechanism
26: lock member
27: striker
28: lock spring
29: cable
30: lever
31: protruding portion
32: hole
35: armrest
36: wheel
37: lock device
38: storage portion
39: floor reinforcing member
40: honeycomb plate

### Second Embodiment

V2, V2A: vehicle
S2: vehicle seat
BT2: battery
201: first floor
202: second floor
203: protrusion portion
204: foot mounting portion (foot bracket)
220: foot bracket

### Third Embodiment

V3: vehicle
FS3: front seat
RS3: rear seat
BT3: battery unit
301: floor
302: recess portion
320: long rail
321: lid

### Fourth Embodiment

V4: vehicle
BT4: battery
401: first floor
402: second floor
410, 410A: rail mounting bracket
411: mounting point
412: opening portion
413, 413A: inclined portion
420: long rail

### Fifth Embodiment

RS5, RS5A: rear seat
501: first floor
502: second floor
510: foot bracket
511: reinforcing member
520, 520A: base

### Sixth Embodiment

V6: vehicle
S6, S6A: vehicle seat
BT6: battery
D6: door panel
TB: table
601: first floor
602: second floor
610: storage portion
611: lid portion

### Seventh Embodiment

V7: electric vehicle
S7: vehicle seat
BT7: battery
701: first floor
702: second floor
710: shock absorbing material
711: reinforcing panel
712: floor mat

### Eighth Embodiment

V8: vehicle
S8: vehicle seat
BT8: battery
802: floor
810: storage recess portion
810a: bottom portion

### Ninth Embodiment

V9: electric vehicle
S9: vehicle seat
BT9: battery
901: first floor
902: second floor
910: protrusion portion
911: side wall
920: mounting portion

### Tenth Embodiment

S10: conveyance seat
Vo1, Vo2: occupied volume
R100, R110: diameter
1001: rotation axis

### Eleventh Embodiment

V11: vehicle
RS11, RS11A: rear seat
S11B: seat
W1101: seat width
W1102: distance between wheel houses
D11, D11A, D11B: shortened width
F11: cushion frame
1101: wheel house
1102: seat cushion
1110, 1111, 1112: air cell
1120: long rail
1121: support member

### Twelfth Embodiment

V12: vehicle
FS12: front seat
RS12: rear seat
BT12: battery
1202: floor panel
1202a: upper floor
1202b: stepped portion
1202c: lower floor
1203: pedestal
1210: link

### Thirteenth Embodiment

V13: electric vehicle
S13: seat
BT13: battery
1301: battery case
1303: battery cooling layer
1304: pre-battery cooling refrigerant transport pipe
1305: high temperature refrigerant transport pipe
1306: heat sink
1307: charging insertion port
1310: charging plug
1314: charging terminal
1311: discharge port
1312: recovery port

### Fourteenth Embodiment

V14, V14A: electric vehicle
FS14: front seat
RS14: rear seat
BT14: battery
1403: motor
1404: rail
1405, 1405A: battery storage tunnel
1406: battery lock
1407, 1407A: insertion hole
1408, 1408A: position recognition mark

### Fifteenth Embodiment

S15, S15C: conveyance seat
1501: occupant protection device
1503: main airbag
1504, 1504A, 1504B, 1504C: sub-airbag
1505: collision prediction unit
1506: deployment control unit
1507: mobile terminal
1510: first bag portion
1511, 1511A, 1511B, 1511C: second bag portion
1512: joint portion
1514: breaking portion
1515: non-breaking portion
1516, 1516C: third bag portion
1517: submarine airbag
1518: gap
1519: airbag storage portion

1. A vehicle, comprising:
a seat on which an occupant is seated;
a rail for sliding the seat;
a first floor in which a plurality of protrusion portions protruding upward are formed; and
a second floor provided above the first floor,
wherein the rail is disposed below the second floor and across the plurality of protrusion portions of the first floor, and
the seat is disposed above the second floor and is slidably connected to the rail.

2. The vehicle according to claim 1,
wherein each of the plurality of protrusion portions extends in a vehicle width direction, and the plurality of protrusion portions are arranged in a vehicle front to rear direction.

3. The vehicle according to claim 1,
wherein a plurality of the seats are provided, and two or more of the seats are disposed on the rail in a front to rear direction of the vehicle.

4. The vehicle according to claim 1,
wherein the rail is disposed across three or more protrusion portions.

5. The vehicle according to claim 1, further comprising:
a rail support member that is disposed between the plurality of protrusion portions and supports the rail from below.

6. The vehicle according to claim 1,
wherein at least one of the plurality of protrusion portions is formed to be lower in height than the other protrusion portions, and
a raising member is provided on the protrusion portion that is lower in height than the other protrusion portions to match a height of the other protrusion portions.

7. The vehicle according to claim 1,
wherein a recess portion is formed on an upper surface of the plurality of protrusion portions, and the rail is disposed in the recess portion.

8. The vehicle according to claim 1,
wherein one end of the rail is in contact with a side surface of a vehicle body structure portion that stands up from the first floor.

9. The vehicle according to claim 1,
wherein the rail is constituted by a lower rail fixed to the first floor and an upper rail that slides on the lower rail, and
the upper rail is provided with a seat attachment/detachment mechanism for attachably/detachably connecting the seat.

10. The vehicle according to claim 1,
wherein a plurality of the rails are provided, and
a floor support member that is disposed between the plurality of rails on the first floor and supports the second floor is provided.
